(19) United States
(12) Patent Application Publication
(10) Pub. No.: US 2023/0058907 A1
(43) Pub. Date: Feb. 23, 2023

(54) ANTIGLARE FILM AND MANUFACTURING METHOD OF ANTIGLARE FILM

(71) Applicant: FUJIFILM Corporation, Tokyo (JP)

(72) Inventors: Nobuyuki AKUTAGAWA, Kanagawa (JP); Motoki ONISHI, Kanagawa (JP)

(73) Assignee: FUJIFILM Corporation, Tokyo (JP)

(21) Appl. No.: 17/954,869

(22) Filed: Sep. 28, 2022

Related U.S. Application Data
(63) Continuation of application No. PCT/JP2021/014545, filed on Apr. 5, 2021.

(30) Foreign Application Priority Data
Apr. 10, 2020 (JP) 2020-071190

(51) Int. Cl. G02B 5/00; G02B 1/14; B29D 11/00

(52) U.S. Cl. CPC G02B 5/003; G02B 1/14; B29D 11/00865

(57) ABSTRACT

An antiglare film includes, in order: a substrate; a first layer; and a second layer with an uneven structure including elongated projection portions on a surface opposite to a substrate side and an arithmetic mean height Sa on that side of the substrate is 30 to 160 nm, an average distance between adjacent elongated projection portions is 5 to 80 μm, a content of particles having a particle diameter of 300 nm or more in the second layer is 0% to 0.1% by mass with respect to a total mass of the second layer, an average film thickness of the second layer is 0.3 to 3 μm, a haze of the antiglare film is 1% to 20%, and where a surface of the antiglare film on the opposite to the substrate side is rubbed 100 times with #0000 steel wool under a load of 1 kg/cm², no scratch occurs.

### CROSS REFERENCE TO RELATED APPLICATION

This is a continuation of International Application No. PCT/W20211014545 filed on Apr. 5, 2021, and claims priority from Japanese Patent Application No. 2020-071190 filed on Apr. 10, 2020, the entire disclosures of which are incorporated herein by reference.

### BACKGROUND OF THE INVENTION

### 1. Field of the Invention

The present invention relates to an antiglare film and a manufacturing method of an antiglare film.

### 2. Description of the Related Art

In various image display apparatuses, such as a liquid crystal display (LCD), a plasma display panel (PDP), an electroluminescent display (ELD), a micro light emitting diode (LED), and a micro organic light emitting diode (OLED), in order to prevent the reflection of external light and the contrast reduction caused by the reflection of images, an antiglare film is used on the surface of the display.

The antiglare film is an optical film configured with a substrate and an antiglare layer having unevenness on a surface thereof, and is known to express antiglare characteristics by scattering light on the surface of the antiglare layer (by surface scattering properties).

Furthermore, an antiglare antirefiection film is also known which further has a layer of low refractive index laminated on an antiglare layer to express antireflection properties in addition to antiglare characteristics. It is known that in order for this antiglare antirefiection film to express the an ti reflection properties, usually, the layer of low refractive index needs to have a small film thickness.

For example, WO2008/084604A describes an antirefiection film having an antiglare layer with an uneven microstructure on a transparent substrate and a layer of low refractive index having a thickness of 0.05 to 0.20 μm on the antiglare layer, WO2008/084604A discloses a technique of forming an antiglare layer by coating a transparent substrate with a coating liquid prepared by dispersing fine particles in a binder.

JP2018-77279A describes a transparent substrate obtained by curing an intermediate laminate comprising a substrate, an antireflection layer having an irregular uneven structure on a surface thereof, and a layer of a semi-cured substance placed between the substrate and the antireflection layer. JP2018-77279A discloses a technique of forming an uneven structure by using a transfer mold.

However, in a case where the antiglare film described in WO2008/0846044A or JP2018-77279A is disposed on a display surface of an image display apparatus, the uneven structure on the surface acts as a lens and leads to the problem of occurrence of glare.

As an antiglare film that suppresses glare, JP2014-85371A discloses an antiglare film including an antiglare layer with a surface having elongated projection portions formed by the phase separation of a plurality of resin components.

### SUMMARY OF THE INVENTION

However, as a result of examinations by the inventors of the present invention, it has been found that although the antiglare film described in JP2014-85371A has excellent antiglare Characteristics and excellently suppresses glare, the surface of the film has a problem with scratch resistance.

An object of the present invention is to provide an antiglare film that has excellent antiglare characteristics, suppresses glare, and has excellent scratch resistance, and a manufacturing method of the antiglare film.

[1]

As a result of intensive examinations, the inventors of the present invention have found that the above object can be achieved by the following means.

An antiglare film having a substrate, a first layer, and a second layer in this order,

in which the second layer has an uneven structure including elongated projection portions on a surface opposite to a side of the substrate,

an arithmetic mean height Sa of the surface of the second layer opposite to the side of the substrate is 30 to 160 μm,

an average distance between adjacent elongated projection portions in the uneven structure is 5 to 80 nm,

a content of particles having a particle diameter of 300 nm or more in the second layer is 0% to 0.1% by mass with respect to a total mass of the second layer,

an average film thickness of the second layer is 0.3 to 3 nm,

a haze of the antiglare film is 1% to 20%, and

in a case where a surface of the antiglare film opposite to the side of the substrate is rubbed 100 times back and forth with #0000 steel wool under a load of 1 kg/cm², no scratch occurs.

The antiglare film described in [1], in which an absolute value Δn of a difference between a refractive index n1 of the first layer and a refractive index n2 of the second layer, the Δn being represented by the following Equation (i), is 0.05 or less.

Δn=|n1−n2| (i)

[3]

The antiglare film described in [1] or [2], in which an absolute value ΔG of a difference between an elastic modulus G1 of the first layer and an elastic modulus G2 of the second layer, the ΔG being represented by the following Equation (ii), is 2 GPa or less.

ΔG=|G1−G2| (ii)

[4]

The antiglare film described in any one of [1] to [3], in which the arithmetic mean height Sa of the surface of the second layer opposite to the side of the substrate is 40 to 100 nm.

[5]

The antiglare film described in any one of 111 to [4], in which the haze of the antiglare film is 5% to 10%.

[6]

The antiglare film described in any one of 111 to 151, in which the average distance between adjacent elongated projection portions in the uneven structure is 5 to 15 μm.

[7]

A manufacturing method of an antiglare film having a substrate, a first layer, and a second layer in this order,

in which the second layer has an uneven structure including elongated projection portions on a surface opposite to a side of the substrate,

an arithmetic mean height Sa of the surface of the second layer opposite to the side of the substrate is 30 to 160 nm,

an average distance between adjacent elongated projection portions in the uneven structure is 5 to 80 μm,

a content of particles having a particle diameter of 300 nm or more in the second layer is 0% to 0.1% by mass with respect to a total mass of the second layer,

an average film thickness of the second layer is 0.3 to 3 μm,

a haze of the antiglare film is 1% to 20%, and

in a case where a surface of the antiglare film opposite to the side of the substrate is rubbed 100 times back and forth with #0000 steel wool under a load of 1 kg/cm′, no scratch occurs, the manufacturing method including, in the following order,

coating the substrate with a composition for forming a first layer containing a polymerizable compound (a1) to form a first layer coating film,

semi-curing the first layer coating film,

coating the semi-cured first layer coating film with a composition for forming a second layer to form a second layer coating film, and

curing the semi-cured first layer coating film and the second layer coating film to form the first layer and the second layer.

[8]

The manufacturing method of an antiglare film described in [7], in which an arithmetic mean height Sat of a surface of the first layer coating film semi-cured in the semi-curing, the surface being opposite to the side of the substrate, is 30 nm or less.

[9]

The manufacturing method of an antiglare film described in [7] or [8], in which a consumption rate of polymerizable groups in the polymerizable compound (a1) in the first layer coating film semi-cured in the semi-curing is 1% to 40%.

[10]

The manufacturing method of an antiglare film described in any one of [7] to [9], in which a recovery rate of the first layer coating film semi-cured in the semi-curing is 2% to 50%.

According to the present invention, it is possible to provide an antiglare film that has excellent antiglare characteristics, suppresses glare, and has excellent scratch resistance and to provide a manufacturing method of the antiglare film.

### BRIEF DESCRIPTION OF THE DRAWINGS

FIG. 1 is a 3D scanning white light interference micrograph of a surface of a second layer of an antiglare film obtained in Example 1.

FIG. 2 is a planar scanning white light interference micrograph of the surface of the second layer of the antiglare film obtained in Example 1.

FIG. 3 is a 3D scanning white light interference micrograph of a surface of a second layer of an antiglare film obtained in Example 2.

FIG. 4 is a planar scanning white light interference micrograph of the surface of the second layer of the antiglare film obtained in Example 2.

### DESCRIPTION OF THE PREFERRED EMBODIMENTS

Hereinafter, embodiments of the present invention will be specifically described, but the present invention is not limited thereto. In the present specification, in a case where numerical values represent a value of physical properties, a value of characteristics, and the like, the description of “(numerical value 1) to (numerical value 2)” means “(numerical value 1) or more and (numerical value 2) or less”. In addition, in the present specification, the description of “(meth)acrylate” means “at least one of acrylate or methacrylate”. The same shall be applied to “(meth)acrylic acid”, “(meth)acryloy”, “(meth)acrylamide”, “(meth)acryloyloxy”, and the like.

[Antiglare Film]

The antiglare film according to an embodiment of the present invention is an antiglare film having a substrate, a first layer, and a second layer in this order,

in which the second layer has an uneven structure including elongated projection portions on a surface opposite to a side of the substrate,

an arithmetic mean height Sa of the surface of the second layer opposite to the side of the substrate is 30 to 160 nm,

an average distance between adjacent projection portions in the uneven structure is 5 to 80 μm,

a content of particles having a particle diameter of 300 nm or more in the second layer is 0% to 0.1% by mass with respect to a total mass of the second layer,

an average film thickness of the second layer is 0.3 to 3 μm,

a haze of the antiglare film is 1% to 20%, and

in a case where a surface of the antiglare film opposite to the side of the substrate is rubbed 100 times back and forth with #0000 steel wool under a load of 1 kg/cm², no scratch occurs.

The reason why the antiglare film according to the embodiment of the present invention has effects, such as excellent antiglare characteristics, suppression of glare, and excellent scratch resistance, has not yet been completely clarified, but is assumed to be as below according to the inventors of the present invention.

The antiglare film according to the embodiment of the present invention has elongated projection portions on the surface of the second layer, and is considered to express antiglare characteristics due to a specific uneven structure formed of the elongated projection portions. Furthermore, it is considered that because the uneven structure is composed of the elongated projection portions rather than being composed of particles as in the related art, a lens effect is unlikely to be produced, and glare could be suppressed.

As will be described later, it is suitable for the antiglare film according to the embodiment of the present invention to be manufactured by a method including a step of semi-curing the first layer coating film formed on the substrate and coating the semi-cured first layer coating film with a composition for forming a second layer. It is considered that in the above step, a part of the composition for forming a second layer may permeate the semi-cured first layer coating film, and volume expansion may occur in the film thickness direction of the film during the subsequent drying and curing, which may form the elongated projection portions.

Hereinafter, the antiglare film according to the embodiment of the present invention will be specifically described.

The antiglare film according to the embodiment of the present invention (also called the film according to the embodiment of the present invention) has at least a substrate, a first layer, and a second layer.

The antiglare film according to the embodiment of the present invention has the substrate, the first layer, and the second layer in this order. That is, in the antiglare film according to the embodiment of the present invention, the first layer and the second layer are laminated in this order on the substrate.

(Uneven Structure of Second Layer)

The second layer has an uneven structure including elongated projection portions, on a surface opposite to the side of the substrate. Due to the uneven structure, the antiglare film according to the embodiment of the present invention can express antiglare characteristics.

The arithmetic mean height Sa of the surface of the second layer opposite to the side of the substrate is 30 to 160 nm. In a case where the arithmetic mean height Sa of the surface of the second layer in the antiglare film according to the embodiment of the present invention is within the above range, the uneven structure is unlikely to bring about a lens effect, and even though the antiglare film is disposed on a display surface of an image display apparatus (particularly, a high-definition image display apparatus), the antiglare film can suppress glare without impairing antiglare characteristics.

The arithmetic mean height Sa is specified in ISO25178, and is determined by calculating the data measured using a scanning white light interference microscope vertscan (registered trademark) 2.0, Hitachi High-Tech Science Corporation) in a wave mode under the measurement condition of a 10× objective lens by analysis software VS-Viewer for the same microscope. ISO is an abbreviation for International Organization for Standardization.

The arithmetic mean height Sa of the surface of the second layer opposite to the side of the substrate is 30 to 160 nm, preferably 40 to 100 nm, more preferably 45 to 100 nm, and even more preferably 45 to 60 nm.

—Elongated Projection Portions—

The shape of the elongated projection portions present on the surface of the second layer is not particularly limited as long as the projection portions have an elongated shape (that is, the shape of the elongated projection portions is not particularly limited unless the projection portions are cubes or spheres).

The elongated projection portions may be, for example, in the shape of lines. In a case where the elongated projection portions are in the shape of lines (strings), the lines may be straight lines, polygonal lines, or curves.

The elongated projection portions may or may not have a branched structure.

Furthermore, the elongated projection portions may be in the form of a mesh.

It is preferable that the antiglare film according to the embodiment of the present invention have a plurality of elongated projection portions. The elongated projection portions may have the same shape or different shapes. It is preferable that the elongated projection portions have different shapes (that is, it is preferable that the elongated projection portions be uneven in shape). In addition, the size (length, width, and height) of the elongated projection portions may be the same or different for the elongated projection portions. It is preferable that the size be different for the elongated projection portions (that is, it is preferable that the elongated projection portions be uneven in size).

In the uneven structure, the average distance between adjacent projection portions (average distance between projections) is 5 to 80 μm.

The average distance between adjacent projection portions in the uneven structure is the average of a distance A between a certain elongated projection portion and another elongated projection portion adjacent to the aforementioned elongated projection portion. In an image of the surface of the second layer that is captured in a direction orthogonal to the surface of the substrate by using a scanning white light interference microscope (vertscan (registered trademark) 2.0, Hitachi High-Tech Science Corporation.), the distance A represents a distance between a point a on the contour (outline) of a certain elongated projection portion and a point b on the contour (outline) of another elongated projection portion adjacent to the aforementioned elongated projection portion. Among the points on the contour (outline) of an elongated projection portion intersecting with a straight line c orthogonal to a tangent of the point a, the point b is a point present in a direction opposite to a direction from the point a toward the inside of the elongated projection portion to which the point a belongs. The point 11 is a point that is at the shortest distance from the point a.

The average distance between adjacent projection portions in the uneven structure is the average of distances measured at any 10 or more sites.

In a case where the average distance exceeds 80 μm, the antiglare performance resulting from the uneven structure of the surface cannot be fully exhibited.

The average distance between adjacent projection portions in the uneven structure is preferably 5 to 60 μm, more preferably 5 to 50 μm, even more preferably 5 to 30 μm, particularly preferably 5 to 20 μm, and most preferably 5 to 15 μm.

The elongated projection portions are preferably elongated projection portions each having a total length of 100 μm or more (preferably 200 μm or more, and more preferably 500 μm or more). “Total length” of the elongated projection portions means the entire length of each of the elongated projection portions. For an elongated projection portion having a branched structure, the total length means the entire length determined by summing up the lengths of branches.

In a plan view of the second layer (in a case where the second layer is seen in a direction orthogonal to the surface of the substrate), usually, the elongated projection portions have a string shape (two-dimensional shape) that partially or totally forms a curve portion. The average width of the elongated projection portions is preferably 0.1 to 30 μm, more preferably 0.1 to 20 μm, even more preferably 0.1 to 15 μm, particularly preferably 0.1 to 10 μm, and most preferably 0.1 to 5 μm. In a case where the average width of the elongated projection portions is 0.1 μm or more, the antiglare characteristics can be easily obtained. In a case where the average width of the elongated projection portions is 30 μm or less, the effect of suppressing glare can be easily obtained.

In the antiglare film according to the embodiment of the present invention, not all the projection portions present on the surface of the second layer need to have an elongated shape, and the surface of the second layer may include other projection portions non-elongated projection portions).

Within the surface of the second layer, the length ratio of the elongated projection portions to other projection portions, for example, length of elongated projection portions/length of other projection portions can be selected within a range of 100/0 to 10/90. The length ratio is, for example, about 100/0 to 30/70, preferably about 100/0 to 50/50, and more preferably about 100/0 to 70/30 (particularly about 100/0 to 90/10). The length ratio is particularly preferably about 100% (for example, the entire surface includes only elongated projection portions).

Within the surface of the second layer, the area ratio of all the projection portions to the total surface area is, for example, about 10% to 100%, preferably about 30% to 100%, and more preferably about 50% to 100% (particularly about 70% to 100%). In a case where the area ratio is within the above range, it is easy to accomplish both the antiglare characteristics and suppression of glare.

The length, width, shape (whether or not the elongated projection portions have a branched structure, or the like), and area of the elongated projection portions can be measured or evaluated based on the two-dimensional shape observed in a micrograph. “Average” is the average of values measured at any 10 or more sites. The length ratio of the elongated projection portions to other projection portions can be determined by measuring lengths of the respective projection portions in a region of 1 mm². The shape of the elongated projection portions can be identified by microscopic observation, based on the ridge-shaped (elevated) portion connecting the vertices of the projection portions. In the present specification, the length of the elongated projection portions can be measured as the length of the ridge portions.

(Haze)

The haze (total haze) of the antiglare film according to the embodiment of the present invention is 1% to 20%.

In a case where the haze is 1% or more, the antiglare characteristics can be expressed. In a case where the haze is 20% or less, the feeling of fading can be reduced. The haze of the antiglare film according to the embodiment of the present invention is preferably 1% to 15%, more preferably 3% to 13%, and even more preferably 5% to 10%.

(Scratch Resistance)

In a case where a surface of the antiglare film according to the embodiment of the present invention that is opposite to the side of the substrate is rubbed 100 times back and forth with #0000 steel wool under a load of 1 kg/cm², no scratch occurs. More specifically, in a case where the surface of the antiglare film opposite to the substrate is rubbed 100 times back and forth with steel wool (manufactured by NIHON STEEL WOOL Co., Ltd., grade No. #0000) as a rubbing material in environmental conditions for evaluation: 25° C., relative humidity of 60% under a load of 1 kg/cm², no scratches are confirmed by visual observation.

In a case where the surface of the antiglare film according to the embodiment of the present invention that is opposite to the side of the substrate is rubbed with it 0000 steel wool under a load of 1 kg/cm², the surface of the antiglare film preferably does not scratch even being rubbed back and forth 250 times and more preferably does not scratch even being rubbed back and forth 500 times.

In a case where the antiglare film according to the embodiment of the present invention has a layer configuration of “substrate/first layer/second layer”, the surface opposite to the side of the substrate is the surface of the second layer.

By appropriately adjusting the combination of materials forming the first and second layers in the antiglare film, the conditions of the manufacturing method of the antiglare film that will be described later, for example, the concentration of solid contents of compositions used for forming the first and second layers, or the layer curing conditions, it is possible to make the scratch resistance of the antiglare film fall into the above range.

In the second layer of the antiglare film according to the embodiment of the present invention, the content of particles having a particle diameter of 300 nm or more is 0% to 0.1% by mass with respect to the total mass of the second layer.

This means that the second layer of the antiglare film according to the embodiment of the present invention substantially does not contain particles that form surface unevenness and contribute to the expression of antiglare characteristics.

The content of the aforementioned particles with respect to the total mass of the second layer is preferably 0% to 0.05% by mass, more preferably 0% to 0.01% by mass, and most preferably 0% by mass. That is, it is most preferable that the second layer do not contain such particles.

In the antiglare film according to the embodiment of the present invention, it is preferable that layers other than the second layer substantially do not contain particles having a particle diameter of 300 nm or more. That is, it is preferable that none of the layers of the antiglare film according to the embodiment of the present invention contain particles that form surface unevenness and contribute to the expression of antiglare characteristics.

In the antiglare film according to the embodiment of the present invention, the first layer and the second layer are laminated in this order on the substrate. Although the functions of the first and second layers are not particularly limited, the first layer is preferably a hard coat layer. Furthermore, the second layer is preferably a scratch resistant layer.

The antiglare film according to the embodiment of the present invention may additionally have a functional layer other than the hard coat layer and the scratch resistant layer as the first layer and the second layer.

Examples of the layer configuration of the antiglare film according to the embodiment of the present invention include the following layer configurations.
Substrate/hard coat layer (first layer)/scratch resistant layer (second layer)
Substrate/adhesive layer/hard coat layer (first layer)/scratch resistant layer (second layer)
Substrate/conductive layer/hard coat layer (first layer)/scratch resistant layer (second layer)
Substrate/barrier layer/hard coat layer (first layer)/scratch resistant layer (second layer)
Substrate/ultraviolet absorbing layer/hard coat layer (first layer)/scratch resistant layer (second layer)
Substrate/hard coat layer (first layer)/scratch resistant layer (second layer)/fingerprint stain resistant layer (third layer)

[Substrate]

The antiglare film according to the embodiment of the present invention has a substrate. Hereinafter, preferred aspects of materials of the substrate (materials forming the substrate) and the like will be described.

The transmittance of the substrate used in the antiglare film according to the embodiment of the present invention in a visible light region is preferably 70% or more, more preferably 80% or more, and even more preferably 90% or more.

(Polymer)

It is preferable that the substrate contain a polymer.

As the polymer, a polymer excellent in optical transparency, mechanical strength, heat stability, and the like is preferable.

Examples of such a polymer include polycarbonate-based polymers, polyester-based polymers such as polyethylene terephthalate (PET) and polyethylene naphthalate (PEN), styrene-based polymers such as polystyrene and an acrylonitrile/styrene copolymer (AS resin), and the like. The examples also include polyolefins such as polyethylene and polypropylene, norbornene-based resins, polyolefin-based polymers such as ethylene/propylene copolymers, (meth)acrylic polymers such as polymethyl methacrylate, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, polyoxymethylene-based polymers, epoxy-based polymers, cellulose-based polymers represented by triacetyl cellulose, copolymers of the above polymers, and polymers obtained by mixing together the above polymers.

Particularly, amide-based polymers such as aromatic polyamide and imide-based polymers can be preferably used as the substrate, because the number of times of folding at break measured for these polymers by an MIT tester according to Japanese Industrial Standards (IIS) P8115 (2001) is large, and these polymers have relatively high hardness. For example, the aromatic polyamide described in Example 1 of JP5699454B and the polyimides described in JP2015-508345A, JP2016-521216A, and WO2017/014287A can be preferably used as the substrate.

As the amide-based polymer, aromatic polyamide (aramid-based polymer) is preferable.

It is preferable that the substrate contain at least one polymer selected from imide-based polymers or aramid-based polymers.

The substrate can also be formed as a cured layer of an ultraviolet curable resin or a thermosetting resin based on acryl, urethane, acrylic urethane, epoxy, silicone, and the like.

(Softening Material)

The substrate may contain a material that further softens the polymer described above. The softening material refers to a compound that improves the number of times of folding at break. As the softening material, it is possible to use a rubber elastic material, a brittleness improver, a plasticizer, a slide ring polymer, and the like.

Specifically, as the softening material, the softening materials described in paragraphs “0051” to “0114” of JP2016-167043A can be suitably used.

The softening material may be mixed alone with the polymer, or a plurality of softening materials may be appropriately used in combination. Furthermore, the substrate may be prepared using one softening material or a plurality of softening materials without being mixed with the polymer.

That is, the amount of the softening material to be mixed is not particularly limited. A polymer having the sufficient number of times of folding at break itself may be used alone as the substrate of the film or may be mixed with the softening material, or the substrate may be totally (100%) composed of the softening material such that the number of times of folding at break becomes sufficient.

(Other Additives)

Various additives (for example, an ultraviolet absorber, a matting agent, an antioxidant, a peeling accelerator, a retardation (optical anisotropy) regulator, and the like) can be added to the substrate according to the use. These additives may be solids or oily substances. That is, the melting point or boiling point thereof is not particularly limited. In addition, the additives may be added at any point in time in the step of preparing the substrate, and a step of preparing a material by adding additives may be added to a material preparation step. Furthermore, the amount of each material added is not particularly limited as long as each material performs its function.

As those other additives, the additives described in paragraphs “0117” to “0122” of JP2016-167043A can be suitably used.

Each of the above additives may be used alone, or two or more additives among the above additives may be used in combination.

(Thickness of Substrate)

The substrate is preferably in the form of a film.

The thickness of the substrate is more preferably 100 μm or less, even more preferably 80 μm or less, and most preferably 50 μm or less. In addition, from the viewpoint of ease of handling of the substrate, the thickness of the substrate is preferably 3 μm or more, more preferably 5 μm or more, and most preferably 15 μm or more.

A surface treatment may be performed on at least one surface of e substrate.

[First Layer]

The antiglare film according to the embodiment of the present invention has a first layer on the substrate. The first layer is preferably a hard coat layer. The first layer may have functions such as conductivity and harder properties in addition to the hard coat properties.

<Material of First Layer>

Preferred aspects of materials of the first layer (materials forming the first layer) and the like in the antiglare film according to the embodiment of the present invention will be described.

It is preferable that the first layer be formed by curing a composition for forming a first layer. That is, it is preferable that the first layer contain a cured substance of the composition for forming a first layer.

(Polymerizable Compound (a1))

It is preferable that the composition for forming a first layer contain a polymerizable compound (a1) (also called “compound (a1)”). The compound (a1) is not particularly limited, and examples thereof include a radically polymerizable compound, a canonically polymerizable compound, an anionically polymerizable compound, and the like. The compound (a1) is preferably a radically polymerizable compound.

Examples of radically polymerizable groups that the radically polymerizable compound has include a polymerizable unsaturated group which is more preferably a vinyl group, an allyl group, a (meth)acryloyloxy group, or a (meth)acrylamide group, even more preferably a (meth)acryloyloxy group or a (meth)acrylamide group, and particularly preferably a (meth)acrylamide group.

The compound (a1) is preferably a compound having two or more radically polymerizable groups in one molecule, and more preferably a compound having three or more radically polymerizable groups in one molecule.

Examples of preferred aspects of the compound (a1) include a compound having one or more amide bonds, urethane bonds, or urea bonds in one molecule. The compound (a1) is more preferably a compound that has two or more radically polymerizable groups in one molecule and also has one or more amide bonds or urethane bonds.

The aforementioned amide bonds may be amide bonds contained in a radically polymerizable group such as a (meth)acrylamide group.

The molecular weight of the compound (a1) is not particularly limited. The compound (a1) may be a monomer, an oligomer, or a polymer.

—Polyorganosilsesquioxane Having Radically Polymerizable Group—

From the viewpoint of scratch resistance, examples of preferred aspects of the compound (a1) include an aspect in which polyorganosilsesquioxane having a radically polymerizable group (also called polyorganosilsesquioxane (a1-1)) is used as the compound (a1).

The radically polymerizable group of the polyorganosilsesquioxane (a1-1) is preferably a (meth)acryloyloxy group or a (meth)acrylamide group, and more preferably a (meth)acylamide group.

It is preferable that the polyorganosilsesquioxane (a1-1) have a constitutional unit represented by General Formula (S1-1) or a constitutional unit represented by General Formula (S2-1).

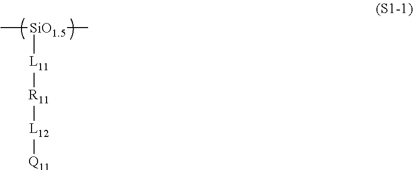

In General Formula (S1-1),

L₁₁ represents a substituted or unsubstituted alkylene group,

R₁₁ represents a single bond, —NH—, —O—. —C(═O)—, or a divalent linking group obtained by combining these,

L₁₂ represents a substituted or unsubstituted alkylene group, and OH represents a radically polymerizable group.

“SiO_{1.5}” in General Formula (S1-1) represents a structural portion composed of a siloxane bond (Si—O—Si) in the polyorganosilsesquioxane.

The polyorganosilsesquioxane is a network-type polymer or polyhedral cluster having a siloxane constitutional unit (silsesquioxane unit) derived from a hydrolysable trifunctional silane compound, and can form a random structure, a ladder structure, a cage structure, and the like by a siloxane bond. In the present invention, although the structural portion represented by “SiO_{1.5}” may be any of the above structures, it is preferable that the structural portion contain many ladder structures. In a case where the ladder structure is formed, the deformation recovery of the hardcoat film can be excellently maintained. Whether the ladder structure is formed can be qualitatively determined by checking whether or not absorption occurs which results from Si—O—Si expansion/contraction unique to the ladder structure found at around 1,020 to 1,050 cm⁻¹ by Fourier Transform Infrared Spectroscopy (Fr-IR).

In General Formula (S1-1), L₁₁ represents an alkylene group which is preferably an alkylene group having 1 to 10 carbon atoms. Examples thereof include a methylene group, a methyl methylene group, a dimethyl methylene group, an ethylene group an i-propylene group, a n-propylene group, a n-butylene group, a n-pentylene group, a n-hexylene group, a n-decylene group, and the like.

In a case where the alkylene group represented by Lit has a substituent, examples of the substituent include a hydroxyl group, a carboxyl group, an alkoxy group, an aryl group, a heteroaryl group, a halogen atom, a nitro group, a cyano group, a silyl group, and the like.

L₁₁ is preferably an unsubstituted linear alkylene group having 2 to 4 carbon atoms, more preferably an ethylene group or a n-propylene group, and even more preferably a n-propylene group.

In General Formula (S1-1), R_{H} represents a single bond, —NH—, —O—, —C(═O)—, or a divalent linking group obtained by combining these.

Examples of the divalent linking group obtained by combining —NH—, —O—, and —C(═O)— include *—NH—C(═O)—**, *—C(═O)—NH—**, *—NH—C(═O)—O—**, C(═O)—NH—, *—C(═O)—O—**, *—O—C(═O)—**, and the like. * represents a bonding site with L₁₁ in General Formula (S1-1), and ** represents a bonding site with L₁₂ in General Formula (S1-1).

R₁₁ is preferably —NH—C(═O)—NH—, *—NH—C(═O)—O—**, *—NH—C(═O)—**, or —O—, and more preferably —NH—C(═O)—NH—, *—NH—C═O)—O—**, or *—NH—C(═O)—**.

In General Formula (S1-1), L₁₂ represents an alkylene group which is preferably an alkylene group having 1 to 10 carbon atoms. Examples thereof include a methylene group, a methyl methylene group, a dimethyl methylene group, an ethylene group an i-propylene group, a n-propylene group, a n-butylene group, a n-pentylene group, a n-hexylene group, a n-decylene group, and the like.

In a case where the alkylene group represented by 142 has a substituent, examples of the substituent include a hydroxyl group, a carboxyl group, an alkoxy group, an aryl group, a heteroaryl group, a halogen atom, a nitro group, a cyano group, a silyl group, and the like.

L₁₂ is preferably a linear alkylene group having 1 to 3 carbon atoms, more preferably a methylene group, an ethylene group, a n-propylene group, or a 2-hydroxy-n-propylene group, and even more preferably a methylene group or an ethylene group.

In General Formula (S1-1), Q₁₁ represents a radically polymerizable group. As the radically polymerizable group, a vinyl group, an allyl group, a (meth)acryloyloxy group, or a (meth)acrylamide group is more preferable, and a (meth)acryloyloxy group or a (meth)acrylamide group is even more preferable.

The constitutional unit represented by General Formula (S1-1) is preferably a constitutional unit represented by General Formula (S1-2).

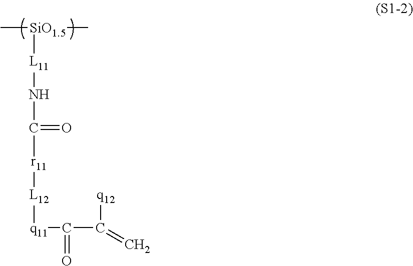

In General Formula (S1-2),

L₁₁ represents a substituted or unsubstituted alkylene group,

r₁₁ represents a single bond, —NH—, or —O—,

L₁₂ represents a substituted or unsubstituted alkylene group,

q₁₁ represents —NH— or —O—, and

q₁₂ represents a hydrogen atom or a methyl group.

“SiO_{1.5}” in General Formula (S1-2) represents a structural portion composed of a siloxane bond (Si—O—Si) in the polyorganosilsesquioxane.

In General Formula (S1-2), L₁₁ represents a substituted or unsubstituted alkylene group. L₁₁ has the same definition as L₁₁ in General Formula (S1-1), and preferred examples thereof are also the same.

In General Formula (S1-2), L₁₂ represents a substituted or unsubstituted alkylene group. L₁₂ has the same definition as L₁₂ in General Formula (S1-1), and preferred examples thereof are also the same.

q₁₂ represents a hydrogen atom or a methyl group, and is preferably a hydrogen atom,

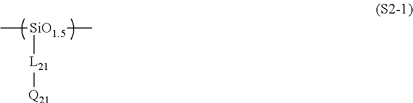

In General Formula (S2-1),

L₂₁ represents a substituted or unsubstituted alkylene group, and

Q₂₁ represents a (meth)acrylamide group.

“SiO_{1.5}” in General Formula (S2-1) represents a structural portion composed of a siloxane bond (Si—O—Si) in the polyorganosilsesquioxane.

In General Formula (S2-1), L₂₁ represents an alkylene group which is preferably an alkylene group having 1 to 10 carbon atoms. Examples thereof include a methylene group, a methyl methylene group, a dimethyl methylene group, an ethylene group an i-propylene group, a n-propylene group, a n-butylene group, a n-pentylene group, a n-hexylene group, a n-decylene group, and the like.

In a case where the alkylene group represented by L₂₁ has a substituent, examples of the substituent include a hydroxyl group, a carboxyl group, an alkoxy group, an aryl group, a heteroaryl group, a halogen atom, a nitro group, a cyano group, a silyl group, and the like.

L₂₁ is preferably an unsubstituted linear alkylene group having 2 to 4 carbon atoms, more preferably an ethylene group or a n-propylene group, and even more preferably a n-propylene group.

As long as the effects of the present invention are not affected, the polyorganosilsesquioxane (a1-1) may have a constitutional unit other than the constitutional unit represented by General Formula. (S1-1) or (S2-1), in the polyorganosilsesquioxane a1-1), the molar ratio of the content of the constitutional unit other than the constitutional unit represented by General Formula (S1-1) or (S2-1) to the total content of constitutional units is preferably 10 mol % or less, and more preferably 5 mol % or less. It is even more preferable that the polyorganosilsesquioxane (a1-1) do not contain a constitutional unit other than the constitutional unit represented by General Formula (S1-1) or (S2.1).

Specific examples of the polyorganosilsesquioxane (a1-1) will be shown below, but the present invention is not limited thereto. In the following structural formulas, “SiO_{1.5}” represents a silsesquioxane unit.

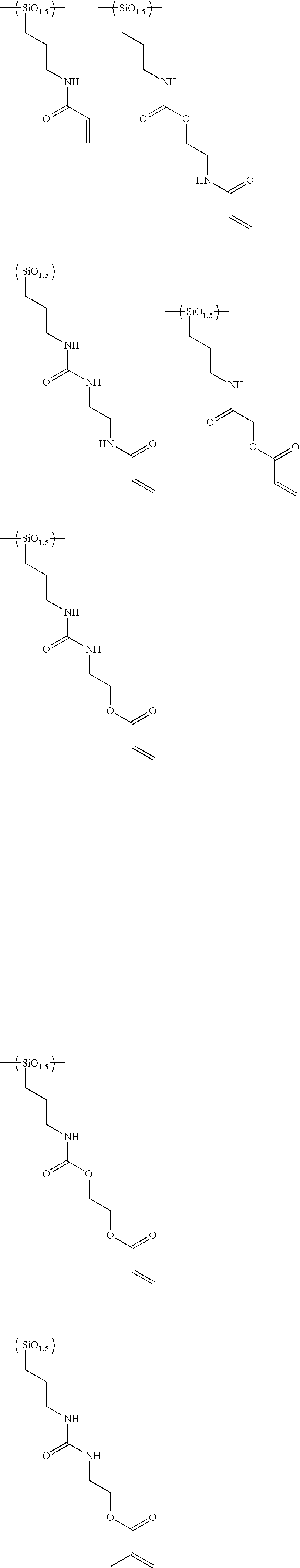

From the viewpoint of improving pencil hardness, the weight-average molecular weight (Mw) of the polyorganosilsesquioxane (a1-1) that is measured by gel permeation chromatography (GPC) and expressed in terms of standard polystyrene is preferably 5,000 to 1,000,000, more preferably 10,000 to 1,000,000, and even more preferably 10,000 to 100,000.

The molecular weight dispersity (Mw/Mn) of the polyorganosilsesquioxane (a1-1) that is measured by GPC and expressed in terms of standard polystyrene is, for example, 1.0 to 4.0, preferably 1.1 to 3.7, more preferably 1.2 to 3.0, and even more preferably 1.3 to 2.5. Mw represents weight-average molecular weight, and Mn represents number-average molecular weight.

The weight-average molecular weight and the molecular weight dispersity of the polyorganosilsesquioxane (a1-1) are measured using the following device under the following conditions.

Measurement device: trade name “LC-20AD” (manufactured by Shimadzu Corporation)

Columns: two Shodex KF-801 columns, KF-802, and KF-803 (manufactured by SHOWA DENKO K. K.)

Measurement temperature: 40° C.

Eluent: N-methylpyrrolidone (NMP), sample concentration of 0.1% to 0.2% by mass

Flow rate: 1 mL/min

Detector: UV-VIS detector (trade name “SPD-20A”, manufactured by Shimadzu Corporation)

Molecular weight: expressed in terms of standard polystyrene

—Manufacturing Method of Polyorganosilsesquioxane (a1-1)—

The manufacturing method of the polyorganosilsesquioxane (a1-1) is not particularly limited. The polyorganosilsesquioxane (a1-1) can be manufactured by known manufacturing methods such as a method of hydrolyzing and condensing a hydrolysable silane compound. As the hydrolysable silane compound, it is preferable to use a compound represented by General Formula (Sd1-1), a compound represented by General Formula (Sd2-1), and the like.

The compound represented by General Formula (Sd1-1) corresponds to the constitutional unit represented by general Formula (S1-1), and the compound represented by General Formula (Sd2-1) corresponds to the constitutional unit represented by General Formula (S2-1).

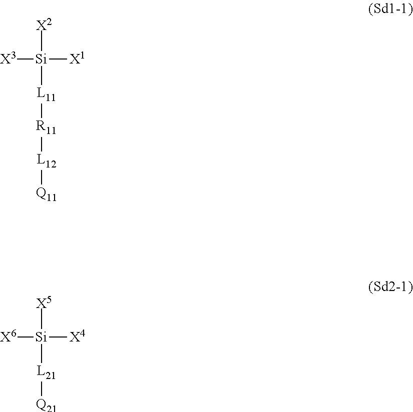

In General Formula (Sd1-1), X¹ to X³ each independently represent an alkoxy group or a halogen atom, L₁₁ represents a substituted or unsubstituted alkylene group, represents a single bond, —NH—, —O—, —C(═O)—, or a divalent linking group obtained by combining these, L₁₂ represents a substituted or unsubstituted alkylene group, and Qu represents a radically polymerizable group. Here, the constitutional unit represented by General Formula (S1-1) has at least one group containing a hydrogen atom capable of forming a hydrogen bond.

In General Formula (Sd2-1), X⁴ to X⁶ each independently represent an alkoxy group or a halogen atom, L₂₁ represents a substituted or unsubstituted alkylene group, and Q₂₁ represents a (meth)acrylamide group.

L₁₁, R₁₁, L₁₂, and Qu in General Formula (Sd1-1) have the same definition as L₁₁, R₁₁, L₁₂, and Q₁₁ in General Formula (S1-1) respectively, and preferable ranges thereof are also the same.

L₂₁ and Q₂₁ in General Formula (Sd2-1) have the same definition as L₂₁ and Q₂₁ in General Formula (S2-1) respectively, and preferable ranges thereof are also the same.

In General Formulas (Sd1-1) and (Sd2-1), X¹ to X⁶ each independently represent an alkoxy group or a halogen atom.

Examples of the alkoxy group include an alkoxy group having 1 to 4 carbon atoms such as a methoxy group, an ethoxy group, a propoxy group, an isopropyloxy group, a butoxy group, and an isobutyloxy group.

Examples of the halogen atom include a fluorine atom, a chlorine atom, a bromine atom, an iodine atom, and the like.

As X¹ to X⁶, an alkoxy group is preferable, and a methoxy group and an ethoxy group are more preferable. X¹ to X⁶ may be the same as or different from each other.

The amount of the above hydrolysable silane compounds used and the composition thereof can be appropriately adjusted depending on the desired structure of the polyorganosilsesquioxane (a1-1).

Furthermore, the hydrolysis and condensation reactions of the hydrolysable silane compounds can be performed simultaneously or sequentially. In a case where the above reactions are sequentially performed, the order of performing the reactions is not particularly limited.

The hydrolysis and condensation reactions of the hydrolysable silane compounds can be carried out in the presence or absence of a solvent, and are preferably carried out in the presence of a solvent.

Examples of the solvent include aromatic hydrocarbons such as benzene, toluene, xylene, and ethylbenzene; ethers such as diethyl ether, dimethoxyethane, tetrahydrofuran, and dioxane; ketones such as acetone, methyl ethyl ketone, and methyl isobutyl ketone; esters such as methyl acetate, ethyl acetate, isopropyl acetate, and butyl acetate; amides such as N,N-dimethylformamide and N,N-diethylacetamide; nitriles such as acetonitrile, propionitrile, and benzonitrile; alcohols such as methanol, ethanol, isopropyl alcohol, and butanol, and the like.

As the solvent, ketones or ethers are preferable. One solvent can be used alone, or two or more solvents can be used in combination.

The amount of the solvent used is not particularly limited. Usually, the amount of the solvent used can be appropriately adjusted depending on the desired reaction time or the like, such that the amount falls into a range of 0 to 2,000 parts by mass with respect to the total amount (100 parts by mass) of the hydrolysable silane compounds.

The hydrolysis and condensation reactions of the hydrolysable silane compounds are preferably performed in the presence of a catalyst and water. The catalyst may be an acid catalyst or an alkali catalyst.

The acid catalyst is not particularly limited, and examples thereof include mineral acids such as hydrochloric acid, sulfuric acid, nitric acid, phosphoric acid, and boric acid; phosphoric acid esters; carboxylic acids such as acetic acid, formic acid, and trifluoroacetic acid; sulfonic acids such as methanesulfonic acid, trifluoromethanesulfonic acid, and p-toluenesulfonic acid; solid acids such as activated clay; Lewis acids such as iron chloride, and the like.

The alkali catalyst is not particularly limited, and examples thereof include alkali metal hydroxides such as lithium hydroxide, sodium hydroxide, potassium hydroxide, and cesium hydroxide; alkali earth metal hydroxides such as magnesium hydroxide, calcium hydroxide, and barium hydroxide; alkali metal carbonate such as lithium carbonate, sodium carbonate, potassium carbonate, and cesium carbonate; alkali earth metal carbonates such as magnesium carbonate; alkali metal hydrogen carbonates such as lithium hydrogen carbonate, sodium hydrogen carbonate, potassium hydrogen carbonate, and cesium hydrogen carbonate; alkali metal organic acid salts (tier example, acetate) such as lithium acetate, sodium acetate, potassium acetate, and cesium acetate; alkali earth metal organic acid salts (for example, acetate) such as magnesium acetate; alkali metal alkoxides such as lithium methoxide, sodium methoxide, sodium ethoxide, sodium isopropoxide, potassium ethoxide, and potassium t-butoxide; alkali metal phenoxides such as sodium phenoxide; amines (tertiary amines and the like) such as triethylamine, N-methylpiperidine, 1,8-diazabicyclo[5.4.0]undec-7-ene, and 1,5-diazabicyclo[4.3.0]non-5-ene; nitrogen-containing aromatic heterocyclic compounds such as pyridine, 2,2′-bipyridyl, and 1,10-phenanthroline, and the like.

One catalyst can be used alone, or two or more catalysts can be used in combination. Furthermore, the catalyst can be used in a state of being dissolved or dispersed in water, a solvent, or the like.

The amount of the catalyst used is not particularly limited. Usually, the amount of the catalyst used can be appropriately adjusted within a range of 0.002 to 0.200 mol with respect to the total amount (1 mol) of the hydrolysable silane compounds.

The amount of water used in the above hydrolysis and condensation reactions is not particularly limited. Usually, the amount of water used can be appropriately adjusted within a range of 0.5 to 40 mol with respect to the total amount (1 mol) of the hydrolysable silane compounds.

The method of adding water is not particularly limited. The entirety of water to be used (total amount of water to be used) may be added at once or added sequentially. In a case where water is added sequentially, the water may be added continuously or intermittently.

The reaction temperature of the hydrolysis and condensation reactions is not particularly limited. For example, the reaction temperature is 40° C., to 100° C. and preferably 45° C. to 80° C. The reaction time of the hydrolysis and condensation reactions is not particularly limited. For example, the reaction time is 0.1 to 15 hours and preferably 1.5 to 10 hours. Furthermore, the hydrolysis and condensation reactions can be carried out under normal pressure or under pressure that is increased or reduced. The hydrolysis and condensation reactions may be performed, for example, in any of a nitrogen atmosphere, an inert gas atmosphere such as argon gas atmosphere, or an aerobic atmosphere such as an air atmosphere. Among these, the inert gas atmosphere is preferable.

By the hydrolysis and condensation reactions of the hydrolysable silane compounds described above, the polyorganosilsesquioxane (a1-1) can be obtained. After the hydrolysis and condensation reactions end, the catalyst may be neutralized. In addition, the polyorganosilsesquioxane (a1) may be separated and purified by a separation method such as rinsing, acid cleaning, alkali cleaning, filtration, concentration, distillation, extraction, crystallization, recrystallization, or column chromatography, or by a separation method using these in combination.

—Urethane (Meth)Acrylate Compound and (Meth)Acrylamide Compound—

Examples of preferred aspects of the compound (a1) include, in addition to the polyorganosilsesquioxane (a1-1), a urethane (meth)acrylate compound and a (meth)acrylamide compound. The urethane (meth)acryl ale compound and the (meth)acrylamide compound are preferably a urethane (meth)acrylate compound and a (meth)acrylamide compound having two or more polymerizable groups in one molecule, and more preferably a urethane (meth)acrylate compound and a (meth)acrylamide compound having three or more polymerizable groups in one molecule.

Specifically, preferable examples thereof include the following compounds.

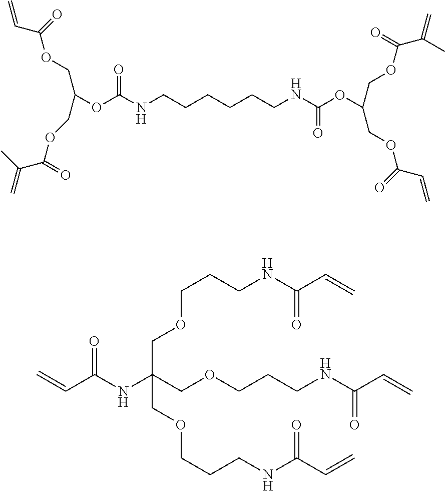

As the compound (a1), one compound may be used alone, or two or more compounds having different structures may be used in combination.

The content of the compound (a1) in the composition for forming a first layer is not particularly limited. The content of the compound (a1) with respect to the total solid content of the composition for forming a first layer is preferably 50% by mass or more, more preferably 70% by mass or more, and even more preferably 80% by mass or more. Furthermore, the content of the compound (a1) in the composition for forming a first layer with respect to the total solid content of the composition for forming a first layer is preferably 99.9% by mass or less, more preferably 98% by mass or less, and even more preferably 97% by mass or less.

The total solid content means all components other than solvents.

<Polymerization Initiator>

It is preferable that the composition for forming a first layer contain a polymerization initiator.

In a case where the compound (a1) used in the composition for forming a first layer has a radically polymerizable group as a polymerizable group, it is preferable that the composition for forming a first layer contain a radical polymerization initiator.

The polymerization initiator is preferably a radical polymerization initiator. The radical polymerization initiator may be a radical photopolymerization initiator or a radical thermal polymerization initiator, and is more preferably a radical photopolymerization initiator.

One polymerization initiator may be used alone, or two or more polymerization initiators having different structures may be used in combination.

As the radical photopolymerization initiator, known radical photopolymerization initiators may be used without particular limitation, as long as the initiators can generate radicals as active species by light irradiation. Specific examples thereof include acetophenones such as diethoxy acetophenone, 2-hydroxy-2-methyl-phenylpropan-one, benzyl di methyl ketal, 4-(2-hydroxyethoxy)phenyl-(2-hydroxy-2-propyl)ketone, -hydroxycyclohexyl phenyl ketone, 2-methyl-2-morpholino(4-thiomethylphenyl)propan-1-one, 2-benzyl-2-dimethylamino-1-(4-morpholinophenyl)butanone, a 2-hydroxy-2-methyl-1-[4-(1-methylvinyl)phenyl]propanone oligomer, and 2-hydroxy-1-{4-[4-(2-hydroxy-2-methyl-propionyl)-benzyl]phenyl}-2-methyl-propan-1-one; oxime esters such as 1,2-octanedione, 1-[4-(phenylthio)-2-(O-benzoyloxime)], ethanone, 1-[9-ethyl-6-(2-methylbenzoyl)-9H-carbazol-3-yl]-, 1-(O-acetyloxime); -benzoins such as benzoin, benzoin methyl ether, benzoin ethyl ether, benzoin isopropyl ether, and benzoin isobutyl ether; benzophenones such as benzophenone, methyl o-benzoyl benzoate, 4-phenylbenzophenone, 4-benzoyl-4-methyl-diphenyl sulfide, 3,3′4,4′-tetra(t-butylperoxycarbonyl)benzophenone, 2,4,6-trimethyl-benzophenone, 4-benzoyl-N,N-dimethyl-N-[2-(1-oxo-2-propenyloxy)ethyl]benzene methanaminium bromide, and (4-benzoylbenzyl)trimethyl ammonium chloride; thioxanthenes such as 2-isopropylthioxanthone, 4-isopropylthioxanthone, 2,4-diethylthioxanthone, 2,4-dichlorothioxanthone, 1-chloro-4-propoxythioxanthone, and 2-(3-dimethylamino-2-hydroxy)-3,4-dimethyl-9H-thioxanthone-9-one methochloride; acylphosphine oxides such as 2,4,6-trimethylbenzoyl-diphenylphosphine oxide, bis(2,6-di methoxybenzoyl)-2,4,4-trimethyl-pentylphosphine oxide, and bis(2,4,6-trimethylbenzoyl)-phenylphosphine oxide; and the like. Furthermore, as an aid for the radical photopolymerization initiator, triethanolamine, triisopropanolamine, 4,4% dimethylamino benzophenone (Michler s ketone), 4,4′-diethylaminobenzophenone, 2-dimethylaminoethyl benzoate, ethyl 4-dimethylaminobenzoate, (n-butoxy)ethyl 4-dimethylaminobenzoate, isoamyl 4-dimethylaminobenzoate, 2-ethylhexyl 4-dimethylaminobenzoate, 2,4-diethylthioxanthone, 2,4-diisopropylthioxanthone, and the like may be used in combination.

The above radical photopolymerization initiators and aids can be synthesized by a known method or are available as commercial products.

The content of the polymerization initiator in the composition for forming a first layer is not particularly limited. For example, the content with respect to 100 parts by mass of the compound (a1) is preferably 0.1 to 200 parts by mass, and more preferably 1 to 50 parts by mass.

<Solvent>

The composition for forming a first layer may contain a solvent.

As the solvent, an organic solvent is preferable. One organic solvent can be used, or two or more organic solvents can be used by being mixed together at any ratio. Specific examples of the organic solvent include alcohols such as methanol, ethanol, propanol, n-butanol, and i-butanol; ketones such as acetone, methyl isobutyl ketone, methyl ethyl ketone, and cyclohexanone; cellosolves such as ethyl cellosolve; aromatic solvents such as toluene and xylene; glycol ethers such as propylene glycol monomethyl ether; acetic acid esters such as methyl acetate, ethyl acetate, and butyl acetate; diacetone alcohol; and the like.

The content of the solvent in the composition for forming a first layer can be appropriately adjusted within a range in which the coating suitability of the composition for forming a first layer can be ensured. For example, the content of the solvent with respect to the total solid content, 100 parts by mass, of the composition for forming a first layer can be 50 to 500 parts by mass, and preferably 80 to 200 parts by mass.

The composition for forming a first layer is generally in the form of a liquid.

The concentration of solid contents of the composition for forming a first layer is generally about 10% to 90% by mass, preferably about 20% to 80% by mass, and particularly preferably about 40% to 70% by mass.

<Other Additives>

The composition for forming a first layer may contain components other than the above, for example, inorganic fine particles, a dispersant, a leveling agent, an antifouling agent, an antistatic agent, an ultraviolet absorber, an antioxidant, a surfactant, and the like.

The surfactant is not particularly limited. For example, a compound having the following structure can be used. In the following structural formula, the ratio of repeating units is the mass ratio.

The molecular weight of the surfactant is not particularly limited. For example, the weight-average molecular weight of the surfactant is preferably 3,000 or less.

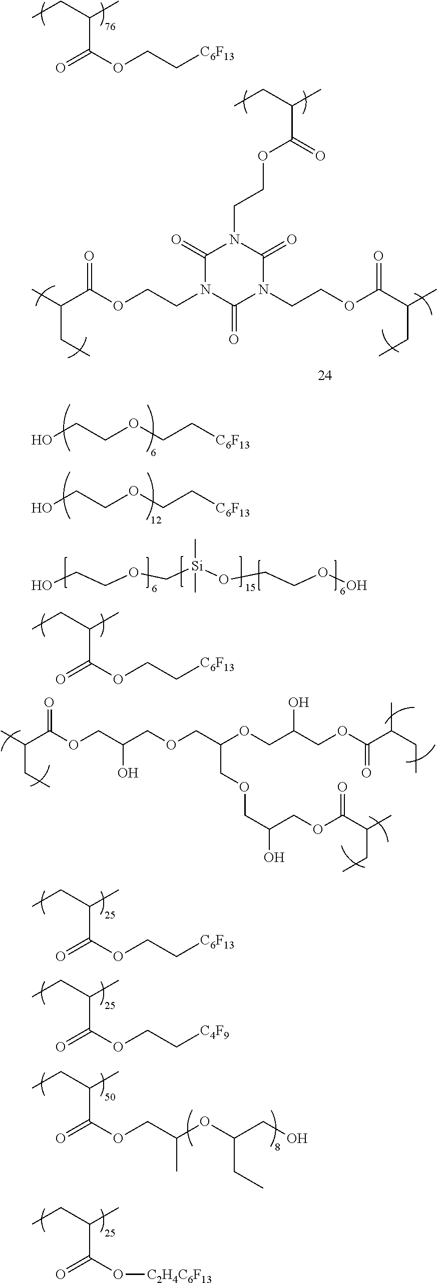

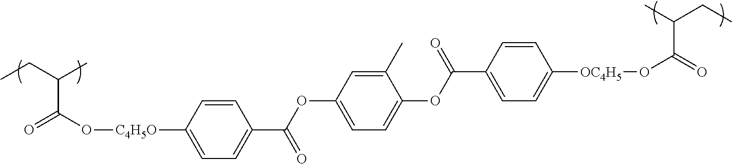

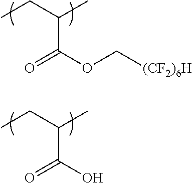

The composition for forming a first layer can be prepared by simultaneously mixing together the various components described above or sequentially mixing together the various components described above in any order. The preparation method is not particularly limited, and the composition can be prepared using a known stirrer or the like.

The first layer of the antiglare film according to the embodiment of the present invention preferably contains a cured substance of the composition for forming a first layer containing the polymerizable compound (at), and more preferably contains a cured substance of the composition for forming a first layer containing the polyorganosilsesquioxane (a1-1) and a polymerization initiator.

It is preferable that the cured substance of the composition for forming a first layer include at least a cured substance formed by the bonding of polymerizable groups of the polymerizable compound (a1) by a polymerization reaction.

In the first layer of the antiglare film according to the embodiment of the present invention, the content of the cured substance of the composition for forming a first layer is preferably 50% by mass or more, more preferably 60% by mass or more, and even more preferably 70% by mass or more.

(Refractive Index of First Layer)

From the viewpoint of interference unevenness, a refractive index n1 of the first layer is preferably 1.48 to 1.70, more preferably 1.50 to 1.65, and even more preferably 1.51 to 1.60.

The refractive index n1 of the first layer can be adjusted, for example, by the type of the polymerizable compound (a1).

The refractive index n1 of the first layer is a refractive index at a wavelength of 550 nm, and is measured using a reflectance spectroscopic Olin thickness meter FE3000 (OTSUKA ELECTRONICS CO., LTD) by multipoint identical analysis (method of calculating a refractive index from samples having the same refractive index and different film thicknesses).

(Elastic Modulus of First Layer)

From the viewpoint of scratch resistance and pencil hardness, an elastic modulus G1 of the first layer at 25° C. is preferably 4 to 15 GPa, more preferably 6 to 12 GPa, and even more preferably 7 to 10 GPa.

The elastic modulus G1 of the first layer can be adjusted, for example, by the type of the polymerizable compound (a1).

To obtain the elastic modulus G1 of the first layer at 25° C., glass was bonded to the substrate side of the first layer by using Aron Alpha (registered trademark) (manufactured by TOAGOSEI CO., LTD.), and then the elastic modulus G1 was measured under the following conditions by using an HM2000 hardness meter (manufactured by Fisher Instruments K.K., with Knoop indenter made of diamond).

Maximum load: 50 mN

Loading time: 10 seconds

Creep: 5 seconds

Unloading time: 10 seconds

Holding time after unloading: 60 seconds

Number of times of measurement: 10

(Film Thickness of First Layer)

The average film thickness of the first layer is not particularly limited, but is preferably 0.5 to 30 μm, more preferably 1 to 25 urn, even more preferably 2 to 20 μm, particularly preferably 2 to 14 μm, and most preferably 2 to 10 μm.

The film thickness of the first layer is calculated by observing a cross section of the antiglare film with a scanning electron microscope (SEM). The cross-sectional sample can be prepared by a microtome method using a cross section cutting device ultramicrotome, a cross section processing method using a focused ion beam (FIB) device, or the like.

[Second Layer]

The antiglare film according to the embodiment of the present invention has a second layer on a side of the first layer opposite to the substrate. The second layer is preferably a scratch resistant layer.

<Material of Scratch Resistant Layer>

Preferred aspects of materials of the second layer (materials forming the second layer) and the like in the antiglare film according to the embodiment of the present invention will be described.

It is preferable that the second layer be formed by curing a composition for forming a second layer. That is, it is preferable that the second layer contain a cured substance of the composition for forming a second layer.

(Polymerizable Compound (c1))

It is preferable that the composition for forming a second layer contain a polymerizable compound (c1) (also called “compound (c1)”). The compound (c1) is not particularly limited, and examples thereof include a radically polymerizable compound, a canonically polymerizable compound, an anionically polymerizable compound, and the like. The compound (c1) is preferably a radically polymerizable compound.

Examples of radically polymerizable groups that the radically polymerizable compound has include a polymerizable unsaturated group. Specifically, the polymerizable unsaturated group is more preferably a vinyl group, an allyl group, a (meth)acryloyloxy group, or a meth)acrylamide group, even more preferably a (meth)acryloyloxy group or a (meth)acrylamide group, and particularly preferably a (meth)acrylamide group.

The compound (c1) is preferably a compound having two or more radically polymerizable groups in one molecule, and more preferably a compound having three or more radically polymerizable groups in one molecule.

Examples of preferred aspects of the compound (c1) include a compound having one or more amide bonds, urethane bonds, or urea bonds in one molecule. The compound (c1) is more preferably a compound that has two or more radically polymerizable groups in one molecule and also has one or more amide bonds or urethane bonds.

The aforementioned amide bonds may be amide bonds contained in a radically polymerizable group such as a (meth)acrylamide group.

The molecular weight of the compound (c1) is not particularly limited. The compound (c1) may be a monomer, an oligomer, or a polymer.

Examples of preferred aspects of the compound (c1) include the polyorganosilsesquioxane (a1-1) exemplified above as the compound (a1), a urethane (meth)acrylate compound, and an acrylamide compound.

As the compound (c1), one compound may be used alone, or two or more compounds having different structures may be used in combination.

As the compound (el), from the viewpoint of controlling surface unevenness, it is preferable to additionally use a compound having two or more (meth)acryloyl groups in one molecule, in combination with the compound exemplified as the compound (a1).

As the compound having two (meth)acryloyl groups in one molecule, for example, neopentyl glycol di(meth)acrylate, di(meth)acrylate, dipropylene glycol di(meth)acrylate, tripropylene glycol di(meth)acrylate, tetraethylene glycol di(meth)acrylate, hydroxypivalic acid neopentyl glycol di(meth)acrylate, polyethylene glycol di(meth)acrylate, dicyclopentenyl (meth)acrylate, dicyclopentenyloxyethyl (meth)acrylate, dicyclopentanyl di(meth)acrylate, compounds obtained by the modification of these compounds (for example, alkylene oxide modification), and the like are suitable.

Examples of the compound having three or more (meth)acryloyl groups in one molecule include esters of a polyhydric alcohol and a (meth)acrylic acid. Specifically, examples thereof include pentaerythritol tri(meth)acrylate, pentaerythritol tetra(meth)acrylate, trimethylolpropane tri(meth)acrylate, trimethylolethane tri(meth)acrylate, ditrimethylolpropane tetra(meth)acrylate, dipentaerythritol tetra(meth)acrylate, dipentaerythritol pentaacrylate, dipentaerythritol hexaacrylate, pentaerythritol hexa(meth)acrylate, compounds obtained by modification of these compounds (for example, alkylene oxide modification), and the like.

In a case where a compound having two or more (meth)acryloyl groups in one molecule is additionally used as the compound (c1), the content of such a compound with respect to the total amount of the compound (c1) is preferably 0% to 90% by mass, more preferably 20% to 80% by mass, and even more preferably 20% to 60% by mass.

The content of the compound (c1) in the composition for forming a second layer with respect to the total solid content in the composition for forming a second layer is preferably 80% by mass or more, more preferably 85% by mass or more, and even more preferably 90% by mass or more.

(Polymerization Initiator)

It is preferable that the composition for forming a second layer contain a polymerization initiator.

In a case where the compound (el) used in the composition for forming a second layer has a radically polymerizable group as a polymerizable group, it is preferable that the composition for terming a second layer contain a radical polymerization initiator.

The polymerization initiator is preferably a radical polymerization initiator. The radical polymerization initiator may be a radical photopolymerization initiator or a radical thermal polymerization initiator, and is more preferably a radical photopolymerization initiator.

The radical polymerization initiator is the same as the radical polymerization initiator which may be contained in the composition for forming a first layer described above.

One polymerization initiator may be used alone, or two or more polymerization initiators having different structures may be used in combination.

The content of the radical polymerization initiator in the composition for forming a second layer is not particularly limited. For example, the content with respect to 100 parts by mass of the compound (c1) is preferably 0.1 to 200 parts by mass, and more preferably 1 to 50 parts by mass.

(Solvent)

The composition for forming a second layer may contain a solvent.

This solvent is the same as the solvent that may be contained in the composition ter forming a first layer described above.

The content of the solvent in the composition for forming a second layer can be appropriately adjusted within a range in which the coating suitability of the composition for forming a second layer can be ensured. For example, the content of the solvent with respect to the total solid content, 100 parts by mass, of the composition for forming a second layer can be 50 to 500 parts by mass, and preferably 80 to 200 parts by mass.

As will be described later, in the antiglare film according to the embodiment of the present invention, the semi-cured first layer coating film is coated with the composition for forming a second layer. It is considered that at this time, a part of the composition for forming a second layer may permeate the semi-cured first layer coating film. It is also preferable to adjust the content of the solvent in the composition for forming a second layer at the time of adjusting the permeability.

The composition for forming a second layer is generally in the form of a liquid.

The concentration of solid contents of the composition for forming a second layer is generally 5% to 50% by mass, preferably 10% to 40% by mass, and particularly preferably 15% to 35% by mass.

(Other Additives)

The composition for forming a second layer may contain components other than the above, for example, inorganic particles, a leveling agent, an antifouling agent, an antistatic agent, a lubricant, a solvent, and the like.

Particularly, it is preferable that the composition for forming a second layer contain the following fluorine-containing compound as a lubricant.

[Fluorine-Containing Compound]

The fluorine-containing compound may be any of a monomer, an oligomer, or a polymer. It is preferable that the fluorine-containing compound have substituents that contribute to the bond formation or compatibility of the fluorine-containing compound with the compound (c1) in the second layer. These substituents may be the same as or different from each other. It is preferable that the compound have a plurality of such substituents.

The substituents are preferably polymerizable groups, and may be polymerizable reactive groups showing any of radical polymerization properties, polycondensation properties, cationic polymerization properties, anionic polymerization properties, and addition polymerization properties. Preferable examples of the substituents include an acryloyl group, a methacryloyl group, a vinyl group, an allyl group, a cinnamoyl group, an epoxy group, an oxetanyl group, a hydroxyl group, a polyoxyalkylene group, a carboxyl group, an amino group, and the like. Among these, radically polymerizable groups are preferable, and particularly, an acryloyl group and a methacryloyl group are preferable.

The fluorine-containing compound may be a polymer or an oligomer with a compound having no fluorine atom.

The fluorine-containing compound is preferably a fluorine-based compound represented by General Formula (F).

(R^{f})—[(W)—(R^{A}_{nf})]_{mf} General Formula (F):

(In the formula, R^{f} represents a (per)fluoroalkyl group or a (per)fluoropolyether group, W represents a single bond or a linking group, and R^{A} represents a polymerizable unsaturated group. nf represents an integer of 1 to 3. mf represents an integer of 1 to 3.)

In General Formula (F), R^{A} represents a polymerizable unsaturated group. The polymerizable unsaturated group is preferably a group having an unsaturated bond capable of causing a radical polymerization reaction by being irradiated with active energy rays such as ultraviolet rays or electron beams (that is, the polymerizable unsaturated group is preferably a radically polymerizable group). Examples thereof include a (meth)acryoyl group, a (meth)acryloyloxy group, a vinyl group, an allyl group, and the like. Among these, a (meth)acryloyl group, a (meth)acryloyloxy group, and groups obtained by substituting any hydrogen atom in these groups with a fluorine atom are preferably used.

In General Formula (F), R^{f} represents a (per)fluoroalkyl group or a (per)fluoropolyether group.

The (per)fluoroalkyl group represents at least one of a fluoroalkyl group or a perfluoroalkyl group, and the (per)fluoropolyether group represents at least one of a fluoropolyether group or a perfluoropolyether group. From the viewpoint of scratch resistance, it is preferable that the fluorine content in R^{f} be high.

The (per)fluoroalkyl group is preferably a group having 1 to 20 carbon atoms, and more preferably a group having 1 to 10 carbon atoms.

The (per)fluoroalkyl group may be a linear structure (for example, —CF₂CF₃, CH₂(CF₂)₄H, —CH₂(CF₂)₈CF₃, —CH₂CH₂(CF₂)₄H), a branched structure (for examples, —CH(CF₃)₂, —CH₂CF(CF₃)₂, —CH(CH₃)CF₂CF₃, —CH(CH₃)(CF₂)₅CF₂H), or an alicyclic structure (preferably a 5- or 6-membered ring, for example, a perfluorocvclohexyl group, a perfluorocyclopentyl group, and an alkyl group substituted with these groups).

The (per)fluoropolyether group refers to a (per)fluoroalkyl group having an ether bond, and may be a monovalent group or a group having a valence of 2 or more. Examples of the fluoropolyether group include —CH₂OCH₂CF₂CF₃, —CH₂CH₂OCH₂C₄H₈H, —CH₂CH₂OCH₂CH₂C₈F₁₇, —CH₂CH₂OCF₂CF₂OCF₂CF₂H, a fluorocycloalkyl group having 4 to 20 carbon atoms with four or more fluorine atoms, and the like. Examples of the perfluoropolyether group include-(CF₂O)_{pf}—(CF₂CF₂O)_{qf}—, —[CF(CF₃)CF₂O]_{pf}—[CF(CF₃)]_{qf}—, —(CF₂CF₂CF₂O)_{pf}—, —(CF₂CF₂O)ₚᵣ—, and the like.

pf and qf each independently represent an integer of 0 to 20. Here, pf+qf is an integer of 1 or more.

The sum of pf and qf is preferably 1 to 83, more preferably 1 to 43, and even more preferably 5 to 23.

From the viewpoint of excellent scratch resistance, the fluorine-containing compound particularly preferably has a perfluoropolyether group represented by —(CF₂O)_{pf}—(CF₂CF₂O)_{qf}—.

In the present invention, the fluorine-containing compound preferably has a perfluoropolyether group and has a plurality of polymerizable unsaturated groups in one molecule.

In General Formula (F), W represents a linking group. Examples of W include an alkylene group, an arylene group, a heteroalkylene group, and a linking group obtained by combining these groups. These linking groups may further have an oxy group, a carbonyl group, a carbonyloxy group, a carbonylimino group, a sulfonamide group, and a functional group obtained by combining these groups.

W is preferably an ethylene group, and more preferably an ethylene group bonded to a carbonylimino group.

The content of fluorine atoms in the fluorine-containing compound is not particularly limited, but is preferably 20% by mass or more, more preferably 30% to 70% by mass, and even more preferably 40% to 70% by mass.

Preferable examples of the fluorine-containing compound include R-2020, M-2020, R-3833, M-3833, and OPTOOL DAC (trade names) manufactured by DAIKIN INDUSTRIES, LTD. and MEGAFACE F-171 F-172, F-179A, RS-78, RS-90, and DEFENSA MCF-300 and MCF-323 (trade names) manufactured by DIC Corporation, but the fluorine-containing compound is not limited to these.

From the viewpoint of scratch resistance, in General Formula (F), the product of nf and mf (nf×mf) is preferably 2 or more, and more preferably 4 or more.

The weight-average molecular weight (Mw) of the fluorine-containing compound having a polymerizable unsaturated group can be measured using molecular exclusion chromatography, for example, gel permeation chromatography (GPC).

Mw of the fluorine-containing compound used in the present invention is preferably 400 or more and less than 50,000, more preferably 400 or more and less than 30,000, and even more preferably 400 or more and less than 25,000.

The content of the fluorine-containing compound with respect to the total solid content in the composition for forming a second layer is preferably 0.01% to 5% by mass, more preferably 0.1% to 5% by mass, even more preferably 0.5% to 5% by mass, and particularly preferably 0.5% to 2% by mass.

The composition for forming a second layer used in the present invention can be prepared by simultaneously mixing together the various components described above or sequentially mixing together the various components described above in any order. The preparation method is not particularly limited, and the composition can be prepared using a known stirrer or the like.

The second layer of the antiglare film according to the embodiment of the present invention preferably contains a cured substance of the composition for forming a second layer containing the compound (c1), and more preferably contains a cured substance of the composition for forming a second layer containing the compound (c1) and a radical polymerization initiator.

The cured substance of the composition for forming a second layer preferably includes at least a cured substance obtained by the polymerization reaction of the radically polymerizable group of the compound (c1).

In the second layer, the content of the cured substance of the composition for forming a second layer with respect to the total mass of the second layer is preferably 60% by mass or more, more preferably 70% by mass or more, and even more preferably 80% by mass or more.

(Refractive Index of Second Layer)

From the viewpoint of interference unevenness, a refractive index n2 of the second layer is preferably 1.48 to 1.70, more preferably 1.50 to 1.65, and even more preferably 1.51 to 1.60.

The refractive index n2 of the second layer can be adjusted, for example, by the type of the polymerizable compound (el).

The refractive index n2 of the second layer is a refractive index at a wavelength of 550 nm, and is measured using a reflectance spectroscopic film thickness meter FE3000 (OTSUKA ELECTRONICS CO., LTD) by multipoint identical analysis (method of calculating a refractive index from samples having the same refractive index and different film thicknesses).

In the antiglare film according to the embodiment of the present invention, an absolute value Δn of a difference between the refractive index n1 of the first layer and the refractive index n2 of the second layer, the Δn being represented by Equation (i), is preferably 0.05 or less.

Δn=|n1−n2| (i)

In a case where Δn is 0.05 or less, it is easy to form a desired uneven structure on the surface during the manufacturing of the film. An is more preferably 0.00 to 0.03, and even more preferably 0.00 to 0.02.

Δn can be adjusted, for example, by appropriately selecting the types of the polymerizable compound (a1) and the polymerizable compound (c

(Elastic Modulus of Second Layer)

From the viewpoint of hardness (scratch resistance or pencil hardness), the elastic modulus G2 of the second layer at 25° C. is preferably 4 to 15 GPa, more preferably 6 to 12 GPa, and even more preferably 7 to 10 GPa.

The elastic modulus G2 of the second layer can be adjusted, for example, by the type of the polymerizable compound (c1).

To obtain the elastic modulus G2 of the second layer at 25° C., glass was bonded to the substrate side of the second layer by using Aron Alpha (registered trademark) (manufactured by TOAGOSEI CO., LTD.), and then the elastic modulus G2 was measured under the following conditions by using an HM2000 hardness meter (manufactured by Fisher Instruments K.K., with Knoop indenter made of diamond).

Maximum load: 50 mN

Loading time: 10 seconds

Creep: 5 seconds

Unloading time: 10 seconds

Holding time after unloading: 60 seconds

Number of times of measurement: 10

In the antiglare film according to the embodiment of the present invention, an absolute value. ΔG of a difference between the elastic modulus G1 of the first layer and the elastic modulus G2 of the second layer, the ΔG being represented by Equation (ii), is preferably 2 GPa or less.

ΔG=|G1−G2| (ii)

In a case where ΔG is 2 GPa or less, it is easy to form a desired uneven structure on the surface during the manufacturing of the film. ΔG is more preferably 0 to 1.5 GPa, and even more preferably 0 to 1.2 GPa.

ΔG can be adjusted, for example, by appropriately selecting the types of the polymerizable compound (a1) and the polymerizable compound (c1).

(Film Thickness of Second Layer)

The average film thickness of the second layer is 0.3 to 3 μm. In a case where the film thickness of the second layer is less than 0.3 μm, scratch resistance deteriorates. Furthermore, in a case where the film thickness of the second layer exceeds 3 μm, sufficient antiglare characteristics cannot be obtained. The film thickness is preferably 0.5 to 2 μm, and more preferably 0.7 to 1 μm.

The film thickness of the second layer is calculated by observing a cross section of the antiglare film with a scanning electron microscope (SEM). The cross-sectional sample can be prepared by a microtome method using a cross section cutting device ultramicrotome, a cross section processing method using a focused ion beam (FIB) device, or the like.

[Manufacturing Method of Antiglare Film]

The manufacturing method of an antiglare film according to an embodiment of the present invention will be described.

The manufacturing method of an antiglare film according to the embodiment of the present invention is a manufacturing method of the antiglare film according to the embodiment of the present invention described above, and includes the following steps (I) to (IV) in this order.

(I) A step of coating the substrate with a composition for forming a first layer containing a polymerizable compound (a1) to form a first layer coating film

(II) A step of semi-curing the first layer coating film

(III) A step of coating the semi-cured first layer coating film with a composition for forming a second layer to form a second layer coating film

(IV) A step of curing the semi-cured first layer coating film and the second layer coating film to form the first layer and the second layer

By the aforementioned manufacturing method of an antiglare film, an antiglare film having a substrate, a first layer, and a second layer in this order is manufactured,

in which the second layer has an uneven structure including elongated projection portions on a surface opposite to a side of the substrate,

an arithmetic mean height Sa. of the surface of the second layer opposite to the side of the substrate is 30 to 160 nm,

an average distance between adjacent projection portions in the uneven structure is 5 to 80 μm,

a content of particles having a particle diameter of 300 nm or more in the second layer is 0% to 0.1% by mass with respect to a total mass of the second layer,

an average film thickness of the second layer is 0.3 to 3 μm,

a haze of the antiglare film is 1% to 20%, and

in a case where a surface of the antiglare film opposite to the side of the substrate is rubbed 100 times back and forth with #0000 steel wool under a load of 1 kg/cm², no scratch occurs.

—Step (I)—

The step (1) is a step of coating the substrate with a composition for forming a first layer containing a polymerizable compound (a1) to form a first layer coating film.

The substrate, the polymerizable compound (a1), and the composition for forming a first layer are as described above.

As the method of coating the substrate with the composition for forming a first layer, known methods can be used without particular limitation. Examples thereof include a dip coating method, an air knife coating method, a curtain coating method, a roller coating method, a wire bar coating method, a gravure coating method, a die coating method, and the like.

—Step (II)—

The step (II) is a step of semi-curing the first layer coating film. “Semi-curing the first layer coating film” means causing a polymerization reaction of some of polymerizable groups of the polymerizable compound (a1) contained in the first layer coating film.

The semi-curing of the first layer coating film is preferably performed by the irradiation with ionizing radiation or by heating.

The type of ionizing radiation is not particularly limited, and examples thereof include X-rays, electron beams, ultraviolet rays, visible light, infrared, and the like. Among these, ultraviolet rays are preferably used. For example, in a case where the first layer coating film can be cured by ultraviolet, it is preferable to irradiate the coating film with ultraviolet from an ultraviolet lamp at an irradiation dose of 10 mJ/cm² to 2,000 mJ/cm² such that only a part of the polymerizable compound (a1) is cured. The ultraviolet irradiation dose is more preferably 20 mJ/cm′ to 500 MI/cm², and even more preferably 40 mJ/cm² to 300 mJ/cm². As the ultraviolet lamp, a metal halide lamp, a high-pressure mercury lamp, or the like is suitably used.

In a case where the coating film is cured by heat, the temperature is not particularly limited, but is preferably 80° C. or higher and 200° C. or lower, more preferably 100° C. or higher and 180° C. or lower, and even more preferably 120° C. or higher and 160° C. or lower.

The oxygen concentration during curing is preferably 0% to 1.0% by volume, more preferably 0% to 0.1% by volume, and most preferably 0% to 0.05% by volume.

The semi-curing of the first layer coating film can be performed by controlling the irradiation dose of ionizing radiation or the heating temperature and time.

Regarding the first layer coating film semi-cured in the step (II), an arithmetic mean height (Sa2) of a surface of the coating film opposite to the side of the substrate is preferably 30 nm or less, more preferably 0 to 20 nm, and even more preferably 0 to 10 nm.

Sa2 is calculated by the same method as the method of calculating Sa described above.

A consumption rate of polymerizable groups in the polymerizable compound (a1) in the first layer coating film semi-cured in the step (II) is preferably 1% to 40%. In a case where the extent of semi-curing of the first layer coating film is adjusted such that the consumption rate falls into the above range, the extent of permeation of the composition for forming a second layer used for coating in the step (111), which will be described later, into the first layer coating film is adjusted, which makes it easy to adjust the surface shape of the second layer in the finally obtained antiglare film to a desired shape. The consumption rate of the polymerizable groups is more preferably 2% to 30%, and even more preferably 3% to 25%.

The consumption rate of the polymerizable groups in the polymerizable compound (a1) is represented by Equation (iii), and is calculated by performing Fourier transform infrared spectroscopy (FT-IR) single-reflection attenuated total reflection (ATR) analysis and measuring the change in peak height derived from double bond groups.

(iii) Consumption rate of polymerizable groups (%)=(peak height derived from double bond groups before semi-curing—peak height derived from double bond groups after semi-curing)/(peak height derived from double bond groups after semi-curing)

A recovery rate of the first layer coating film semi-cured in the step (11) is preferably 2% to 50%. The recovery rate refers to a ratio of the energy applied for indentation (area) and the energy returned (area). That is, in the case of perfect elastic body, the recovery rate is 100%. The recovery rate is calculated by the following equation. To obtain the recovery rate, glass was bonded to one surface of the first layer coating film by using Aron Alpha (registered trademark) (manufactured by TOAGOSEI CO., LTD.), and the recovery rate was measured for the other surface of the first layer coating film (the surface to which glass was not bonded) under the following conditions by using an HM2000 hardness meter (manufactured by Fisher Instruments K.K., with Knoop indenter made of diamond).

Maximum load: 50 mN

Loading time: 10 seconds

Creep: 5 seconds

Unloading time: 10 seconds

Holding time after unloading: 60 seconds

Number of times of measurement: 10

Recovery rate (%)=elastic energy/(elastic energy+plastic energy)

The elastic energy is the area of the SS curve (stress-strain curve) during loading, and the plastic energy is the area of the SS curve after unloading.

The recovery rate is more preferably 2% to 40%, and even more preferably 10% to 30%.

—Step (III)—

The step (III) is a step of coating the semi-cured first layer coating film with a composition for forming a second layer to form a second layer coating film.

The composition for forming a second layer is as described above.

As the method of coating the first layer coating film with the composition for forming a second layer, known methods can be used without particular limitation. Examples thereof include a dip coating method, an air knife coating method, a curtain coating method, a roller coating method, a wire bar coating method, a gravure coating method, a die coating method, and the like.

It is considered that because the first layer coating film is a semi-cured coating film, a part of the composition for forming a second layer used for coating in the step (III) may permeate the first layer coating film.

—Step (IV)—

The step (IV) is a step of curing the semi-cured first layer coating film and the second layer coating film to form the first layer and the second layer.

The curing of the coating film is preferably performed by the irradiation with ionizing radiation or by heating. The irradiation with ionizing radiation and heating are the same as those described in Step (II).

Curing the semi-cured first layer coating film means causing a polymerization reaction of at least some of the polymerizable groups in the unreacted polymerizable compound (a1) contained in the semi-cured first layer coating film. In addition, curing the second layer coating film means causing a polymerization reaction of at least some of the polymerizable groups in the curable compound (preferably the polymerizable compound (c1)) contained in the second layer coating film.

It is preferable to cure the second layer coating film and to fully cure the first layer in the step (IV).

If necessary, a drying treatment may be performed between Step (I) and Step (I), between Step (II) and Step (III), between Step (IMI) and Step (IV), or after Step (IV). The drying treatment can be performed by blowing hot air, disposing the film in a heating furnace, transporting the film in a heating furnace, heating a surface (substrate surface) of the film not being provided with the first layer and the second layer with a roller, and the like. The heating temperature is not particularly limited and may be set to a temperature at which the solvent can be dried and removed. The heating temperature means the temperature of hot air or the internal atmospheric temperature of the heating furnace.

Particularly, it is preferable that there be a drying treatment step between the step (III) and the step (IV). As described above, it is considered that a part of the composition for forming a second layer used for coating in the step (III) may permeate the first layer coating film, which may induce volume expansion of the first layer coating film in the film thickness direction. Therefore, it is considered that drying of the semi-cured first layer coating film and the second layer coating film may result in contraction of the coating films, which may form unevenness on the surface of the second layer coating film. What is important during the drying is the drying speed. In a case where the drying speed is too fast (for example, in a case where the coating films are blasted with too much air), portions where surface unevenness is expressed and portions where surface unevenness is not expressed are likely to be formed within the surface.

[Display Device]

The antiglare film according to the embodiment of the present invention has high scratch resistance and causes less glare. Therefore, the antiglare film according to the embodiment of the present invention can be used in various display devices, such as a liquid crystal display (LCD) device, an organic EL display (OLED) device, a plasma display, and a display device with a touch panel. Especially, the antiglare film according to the embodiment of the present invention can also be used in a high-definition display device of 200 ppi or higher resolution (particularly 300 ppi or higher resolution), as a member that does not impair image quality by glare or corrupted texts. Therefore, the antiglare film according to the embodiment of the present invention can be preferably used in devices that are often used as high-definition display devices, such as a liquid crystal display device (including a liquid crystal display device that may also be a display device with a touch panel) and an organic EL display device (including an organic EL display device that may also be a display device with a touch panel), among the above display devices.

### EXAMPLES

Hereinafter, the present invention will be more specifically described using examples, but the scope of the present invention is not limited thereto.

<Preparation of Substrate>

(Manufacturing of Polyimide Powder)

Under a nitrogen stream, 832 g of N,N-dimethylacetamide (DMAc) was added to a 1 L reactor equipped with a stirrer, a nitrogen injection device, a dropping funnel, a temperature controller, and a cooler, and then the temperature of the reactor was set to 25° C. Bistrifluoromethylbenzidine (TFDB) (64.046 g (0.2 mol)) was added thereto and dissolved. The obtained solution was kept at 25° C., and in this state, 31.09 g (0.07 mol) of 2,2-bis(3,4-dicarboxyphenyl)hexafluoropropane dianhydride (6FDA) and 8.83 g (0.03 mot) of biphenyltetracarboxylic dianhydride (RPDA) were added thereto, and the mixture was allowed to react by being stirred for a certain period of time. Then, 20.302 g (0.1 mol) of terephthaloyl chloride (TPC) was added thereto, thereby obtaining a polyamic acid solution with a concentration of solid contents of 13% by mass. Thereafter, 25.6 g of pyridine and 33.1 g of acetic anhydride were added to the polyamic acid solution, and the mixture was stirred for 30 minutes, further stirred at 70° C. for 1 hour, and then cooled to room temperature. Methanol (20 L) was added thereto, and the precipitated solid contents were filtered and pulverized. Subsequently, the pulverized resultant was dried in a vacuum at 100° C. for 6 hours, thereby obtaining 111 g of polyimide powder.

(Preparation of Substrate S-1)

The aforementioned polyimide powder (100 g) was dissolved in 670 g of N,N-dimethylacetamide (DMAc), thereby obtaining a 13% by mass solution. The obtained solution was cast on a stainless steel plate and dried with hot air at 130° C. for 30 minutes. Then, the film was peeled from the stainless steel plate and fixed to a frame by using pins, and the frame to which the film was fixed was put in a vacuum oven, heated for 2 hours by slowly increasing the heating temperature up to 300° C. from 100° C., and then slowly cooled. The cooled film was separated from the frame. Then, as a final heat treatment step, the film was further treated with heat for 30 minutes at 300° C., thereby obtaining a substrate S-1 having a film thickness of 50 μm consisting of a polyimide film.

(Preparation of Substrate S-2)

A substrate S-2 consisting of a polyimide film and having a thickness of 30 μm was prepared in the same manner as in Preparation of substrate S-1.

(Preparation of Substrate S-3)

[Preparation of Cellulose Acylate Film 1]

(Preparation of Core Layer Cellulose Acylate Dope)

The following composition was put in a mixing tank and stirred to dissolve each component, thereby preparing a cellulose acetate solution to be used as a core layer cellulose acylate dope.

<Core Layer Cellulose Acylate Dope>

| | | |
|---|---|---|
| Cellulose acetate having acetyl substitution degree of 2.88 | 100 | parts by mass |
| Polyester compound B described in Examples of JP2015-227955A | 12 | parts by mass |
| The following compound G | 2 | parts by mass |
| Methylene chloride (first solvent) | 430 | parts by mass |
| Methanol (second solvent) | 64 | parts by mass |

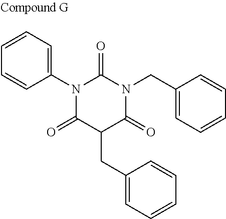 [SMILES: O=C1C(Cc2ccccc2)C(=O)N(c2ccccc2)C(=O)N1Cc1ccccc1]

(Preparation of Outer Layer Cellulose Acylate Dope)

The following matting agent solution (10 parts by mass) was added to 90 parts by mass of the aforementioned core layer cellulose acylate dope, thereby preparing a cellulose acetate solution to be used as an outer layer cellulose acylate dope.

<Matting Agent Solution>

Silica particles having average particle size of 20 nm (AEROSIL
R972, manufactured by Nippon Aerosil Co., Ltd.) 2 parts by mass
Methylene chloride (first solvent) 76 parts by mass
Methanol (second solvent) 11 parts by mass
Core layer cellulose acylate dope described above 1 part by mass

(Preparation of Cellulose Acylate Film 1)

The core layer cellulose acylate dope and the outer layer cellulose acylate dope described above were filtered through filter paper having an average pore diameter of 34 μm and a sintered metal filter having an average pore diameter of 10 mm. Then, the core layer cellulose acylate dope and the outer layer cellulose acylate dope on both sides of the core layer cellulose acylate dope were simultaneously cast as three layers on a drum at 20° C. from a casting outlet. The film was peeled off in a state where a solvent content thereof was about 20% by mass, both ends of the film in the width direction were fixed with tenter clips, and the film was dried while being stretched in the transverse direction at a stretching ratio of 1.1. Then, the obtained film was further dried by being transported between the rolls of a heat treatment device, thereby preparing an optical film having a thickness of 50 μm, which was used as a cellulose acylate film 1. The core layer of the cellulose acylate film 1 had a thickness of 46 un, and each of the outer layers disposed on both sides of the core layer had a thickness of 2 μm. The obtained cellulose acrylate film 1 had an in-plane retardation of 0 nm at a wavelength of 550 nm.

The obtained cellulose acylate film 1 was used as a substrate S-3.

(Synthesis of Polyorganosilsesquioxane (Acrylamide SQ))

3-(Trimethoxysilyl)propyl acrylamide (300 mina 70.0 g), 7.39 g of triethylamine, and 434 g of acetone were mixed together, and 73.9 g of pure water was added dropwise thereto for 30 minutes by using a dropping funnel. The reaction solution was heated to 50° C., and a polycondensation reaction was carried out for 10 hours.

Subsequently, the reaction solution was cooled and neutralized with 12 mL of a 1 mon aqueous hydrochloric acid solution, 600 g of 1-methoxy-2-propanol was added thereto, and then the mixture was concentrated under the conditions of 30 mmHg and 50° C., thereby obtaining polyorganosilsesquioxane, (acrylamide SQ) as a transparent liquid product in a propylene glycol monomethyl ether (PGME) solution having a concentration of solid contents of 49% by mass. 1 mmHg equals 101,325/760 Pa.

The structure of the acrylamide SQ is shown below. In the following structural formulas, “SiO_{1.5}” represents a silsesquioxane unit. The acrylamide SQ had a weight-average molecular weight of 15,100 and a number-average molecular weight of 5,700.

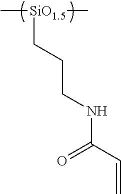

The structural formulas of the polymerizable compounds used in examples and comparative examples will be shown below.

U-4HA: (manufactured SHIN-NAKAMURA CHEMICAL CO, LTD.)

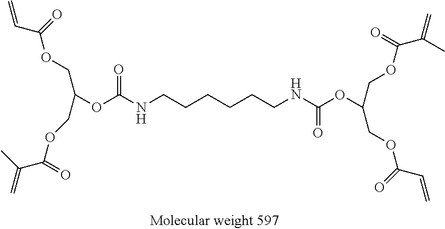 [SMILES: C=CC(=O)OCC(COC(=O)C(=C)C)OC(=O)NCCCCCCNC(=O)OC(COC(=O)C=C)COC(=O)C(=C)C]

FAM-401: (manufactured by FUJIFILM Corporation)

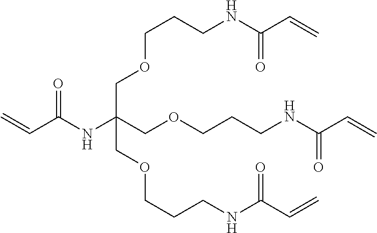 [SMILES: C=CC(=O)NCCCOCC(COCCCNC(=O)C=C)(COCCCNC(=O)C=C)NC(=O)C=C]

A-TMMT: Pentaerythritol tetraacrylate (manufactured by SHIN-NAKAMURA CHEMICAL CO, LTD.)

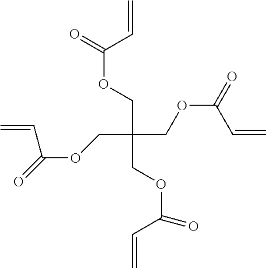 [SMILES: C=CC(=O)OCC(COC(=O)C=C)(COC(=O)C=C)COC(=O)C=C]

DPHA: Dipentaerythritol hexaacrylate (manufactured h SHIN-NAKAMURA CHEMICAL CO, LTD.)

<Preparation of Composition for Forming Hardcoat Layer>

(Preparation of Composition HC-1 for Forming Hardcoat Layer)

A surfactant (Z-1), IRGACURE 127, and PGME were added to a PGME solution of polyomanosilsesquioxane (acrylamide SQ) (concentration of solid contents: 49% by mass), and the content of each component contained in the solution was adjusted as below. The solution was put in a mixing tank and stirred. The obtained composition was filtered through a polypropylene filter having a pore diameter of 0.45 μm, thereby obtaining a composition HC-1 for forming a hardcoat layer.

| | | |
|---|---|---|
| PGME solution of polyorganosilsesquioxane (acrylamide SQ) (concentration | 32.7 | parts by mass |
| of solid contents: 49% by mass) | | |
| Surfactant (Z-1) | 0.018 | parts by mass |
| IRGACURE 127 | 0.46 | parts by mass |
| PGME | 16.83 | parts by mass |

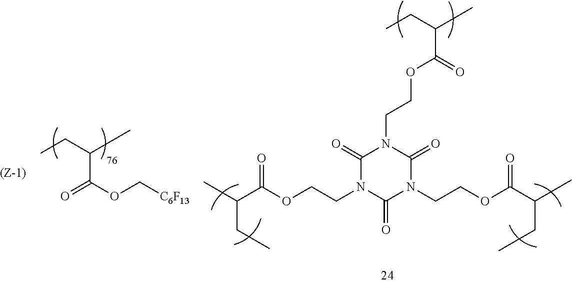

The ratio (76% and 24%) of each constitutional unit in (Z-1) is a mass ratio.

IRGACURE 127 (Irg. 127) is a radical polymerization initiator manufactured by IGM Resin B.V.

(Preparation of Composition HC-2 for Forming Hardcoat Layer)

The surfactant (Z-1), IRGACURE 127, and PGME were added to urethane acrylate (U-4HA), the content of each component was adjusted as follows, and the mixture was put into a mixing tank and stirred. The obtained composition was filtered through a polypropylene filter having a pore diameter of 0.45 μm, thereby obtaining a composition HC-2 for forming a hardcoat layer.

Urethane acrylate (U-4HA) 8.33 parts by mass
Surfactant (Z-1) 0.009 parts by mass
IRGACURE 127 0.24 parts by mass
PGME 17.42 parts by mass

(Preparation of Composition HC-3 for Forming Hardcoat Layer)

The surfactant (Z-1), IRGACURE 127, and PGME were added to an acrylamide monomer (FAM-401), the content of each component was adjusted as follows, and the mixture was put into a mixing tank and stirred. The obtained composition was filtered through a polypropylene filter having a pore diameter of 0.45 μm., thereby obtaining a composition HC-3 for forming a hardcoat layer.

Acrylamide monomer (FAM-401) 8.33 parts by mass
Surfactant (Z-1) 0.009 parts by mass
IRGACURE 127 0.24 parts by mass
Methanol 17.42 parts by mass

<Preparation of Composition for Forming Scratch Resistant Layer>

(Preparation of Composition SR-1 for Forming Scratch Resistant Layer)

Components composed as below were put in a mixing tank, stirred, and filtered through a polypropylene filter having a pore diameter of 0.4 μm, thereby obtaining a composition SR-1 for forming a scratch resistant layer having a concentration of solid contents of 25% by mass.

PGME solution of polyorganosilsesquioxane (acrylamide SQ)
(concentration of solid contents: 49% by mass) 23.52 parts by mass
A-TMMT 12.54 parts by mass
IRGACURE 127 0.69 parts by mass
RS-90 (10% solution) 2.47 parts by mass
PGME 60.79 parts by mass

RS-90 is as follows.

RS-90: lubricant, manufactured by DIC Corporation

(Preparation of Composition SR-2 for Forming Scratch Resistant Layer)

SR-2 was prepared in the same manner as in the preparation of SR-1, except that the amount of PGME added was changed such that the concentration of solid contents in SR-1 was 15% by mass.

(Preparation of Composition SR-3 for Forming Scratch Resistant Layer)

SR-3 was prepared in the same manner as in the preparation of SR-1, except that in the preparation of SR-1, the amount of A-TMMT added was changed such that the content of A-TMMT was 70% by mass with respect to the total amount of acrylamide SQ and A-TMMT.

(Preparation of Composition SR-4 for Forming Scratch Resistant Layer)

SR-4 was prepared in the same manner as in the preparation of SR-1, except that in the preparation of SR-1, the amount of A-TMMT added was changed such that the content of A-TMMT was 80% by mass with respect to the total amount of acrylamide SQ and A-TMMT.

(Preparation of Composition SR-5 for Forming Scratch Resistant Layer)

Components composed as below were put in a mixing tank, stirred, and filtered through a polypropylene filter having a pore diameter of 0.4 μm, thereby obtaining a composition SR-5 for forming a scratch resistant layer having a concentration of solid contents of 25% by mass.

Urethane acrylate (U-4HA) 12.04 parts by mass
A-TMMT 12.04 parts by mass
IRGACURE 127 0.69 parts by mass
RS-90 (10% solution) 2.47 parts by mass
PGME 72.78 parts by mass

(Preparation of Composition SR-6 for Forming Scratch Resistant Layer)

Components composed as below were put in a mixing tank, stirred, and filtered through a polypropylene filter having a pore diameter of 0.4 μm, thereby obtaining a composition SR-6 for forming a scratch resistant layer having a concentration of solid contents of 25% by mass.

DPHA 24.07 parts by mass
IRGACURE 127 0.69 parts by mass
RS-90 (10% solution) 2.47 parts by mass
PGME 72.78 parts by mass

### Example 1

<Manufacturing of Hardcoat Film 1>

A polyimide substrate S-1 having a thickness of 50 μm was coated with the composition HC-1 for forming a hardcoat layer by using a #12 wire bar such that the film thickness was 4.8 μm after curing, thereby providing a coating film as a hardcoat layer on the substrate (step (I)).

Thereafter, the coating film as a hardcoat layer was dried at 120° C. for 1 minute, then grounded on a hot plate at 25° C., and irradiated with ultraviolet at an illuminance of 20 mW/cm² and an irradiation dose of 60 mil cm² by using an air-cooled mercury lamp under the condition of an oxygen concentration of 100 ppm (parts per million). In this way, the coating film as a hardcoat layer was semi-cured (step (H)).

The semi-cured coating film as a hardcoat layer was coated with the composition SR-1 for forming a scratch resistant layer by using a #3 wire bar such that the average film thickness was 0.8 μm after curing, thereby providing a coating film as a scratch resistant layer (step (III)).

Thereafter, the coating film as a scratch resistant layer was dried at 100° C. for 1 minute, then grounded on a hot plate at 25° C., and irradiated with ultraviolet at an illuminance of 52 mW/cm² and an irradiation dose of 600 mJ/cm² by using an air-cooled mercury lamp under the condition of an oxygen concentration of 100 ppm, thereby curing the coating film as a hardcoat layer and the coating film as a scratch resistant layer. In order to further facilitate crosslinking, the sample prepared by curing the coating film as a scratch resistant layer was grounded on a hot plate at 100° C. and irradiated with ultraviolet at an illuminance of 52 mW/cm² and an irradiation dose of 600 mi/chi′ by using an air-cooled mercury lamp under the condition of an oxygen concentration of 100 ppm, thereby forming a hardcoat layer and a scratch resistant layer and obtaining an antiglare film 1 (step (IV)).

The antiglare film 1 has the hardcoat layer as the first layer and the scratch resistant layer as the second layer.

### Examples 2 and 3

Antiglare films 2 and 3 were obtained in the same manner as in Example 1, except that the film thickness of the hardcoat layer after curing and the irradiation dose of ultraviolet (UV irradiation dose) in the step (H) of semi-curing the coating film as a hardcoat layer were changed as described in Table 1.

### Example 4

An antiglare film 4 was obtained in the same manner as in Example 1, except that the substrate was changed to S-3 and that the film thickness of each of the hardcoat layer and the scratch resistant layer after curing was changed as described in Table 1.

### Examples 5 and 6

Antiglare films 5 and 6 were obtained in the same manner as in Example 1, except that the substrate was changed to S-2 and that the type of each of the compositions for forming a hardcoat layer and a scratch resistant layer, the film thickness after curing, and the irradiation dose of ultraviolet (UV irradiation dose) in the step (II) of semi-curing the coating film as a hardcoat layer were changed as described in Table 1.

### Example 7

An antiglare film 7 was obtained in the same manner as in Example 1, except that the concentration of solid contents of the composition SR-1 for forming a scratch resistant layer was changed as described in Table 1.

### Comparative Example

A comparative antiglare film r1 was obtained in the same manner as in Example 1, except that the film thickness of the hardcoat layer after curing and the irradiation dose of ultraviolet (UV irradiation dose) in the step (H) of semi-curing the coating film as a hardcoat layer were changed as described in Table 1 and that SR-2 having a low concentration of solid contents was used instead of the composition SR-1 for forming a scratch resistant layer.

### Comparative Examples 2 and 3

Comparative antiglare films r2 and r3 were obtained in the same manner as in Example 1, except that the type of composition for forming a scratch resistant layer and the film thickness of the scratch resistant layer after curing were changed as described in Table 1.

### Comparative Example 4

A comparative antiglare film r4 was obtained in the same manner as in Example 5, except that the irradiation dose of ultraviolet (UV irradiation dose) in the step (ii) of semi-curing the coating film as a hardcoat layer were changed as described in Table 1.

### Comparative Example 5

As Comparative Example 5, a commercially available antiglare film PF23-125 (manufactured by Daicel Corporation) was used.

<Characteristics of First Layer, Second Layer, and Hardcoat Film>

The arithmetic mean height (Sa2) of a surface of the first layer coating film semi-cured in the step (ii), the surface being opposite to the side of the substrate, the consumption rate of polymerizable groups in the polymerizable compound (a1) in the first layer coating film semi-cured in the step (ii) (polymerizable group consumption rate), and the recovery rate of the first layer coating film semi-cured in the step (ID were determined.

Furthermore, for each of the first and second layers, the refractive indices (n1 and n2) and elastic moduli (G1 and G2) were determined. An and ΔG were obtained from Equations (i) and (ii).

Δn=|n1−n2| (i)

ΔG=|G1−G2| (ii)

In addition, the arithmetic mean height (Sa) of the surface of the second layer opposite to the side of the substrate, the average distance between adjacent projection portions in the uneven structure including the elongated projection portions on the surface of the second layer opposite to the side of the substrate (average distance between projections), and the haze of the antiglare film (total haze) were determined.

In all the examples and comparative examples, the content of particles having a particle diameter of 300 nm or more in the second layer of the antiglare film is 0% by mass with respect to the total mass of the second layer.

(Consumption Rate of Polymerizable Groups)

The consumption rate of polymerizable groups was calculated by the method described above.

(Recovery Rate)

The recovery rate was measured by the method described above,

(Haze)

The haze (total haze) and total light transmittance of the antiglare film were measured. Both the haze and total light transmittance were measured using SH-4000 manufactured by NIPPON DENSHOKU INDUSTRIES Co., Ltd. The haze was measured based on JIS K 7136, and the total light transmittance was measured based on JIS K 7361.

(Sa)

Sa was calculated by the method described above. That is, Sa was determined by calculating the data measured using a scanning white light interference microscope (vertscan (registered trademark) 2.0, Hitachi High-Tech Science Corporation) in a wave mode under the measurement condition of a 10× objective lens by analysis software VS-Viewer for the same microscope.

(Sa2)

For a surface of the first layer coating film semi-cured in the step (II), the substrate being opposite to the side of the substrate, Sa2 was calculated in the same manner as the manner adopted for calculating Sa described above.

(Average Distance Between Projections)

The average distance between projections was calculated by the method described above. The average distance between projections is the average of distances measured at any 10 Sites.

(Refractive index)

n1 and n2 are refractive indices at a wavelength of 550 nm, and are measured using a reflectance spectroscopic film thickness meter FE3000 (OTSUKA ELECTRONICS CO., LTD) by multipoint identical analysis (method of calculating a refractive index from samples having the same refractive index and different film thicknesses).

(Elastic Modulus)

G1 and G2 were measured by the method described above.

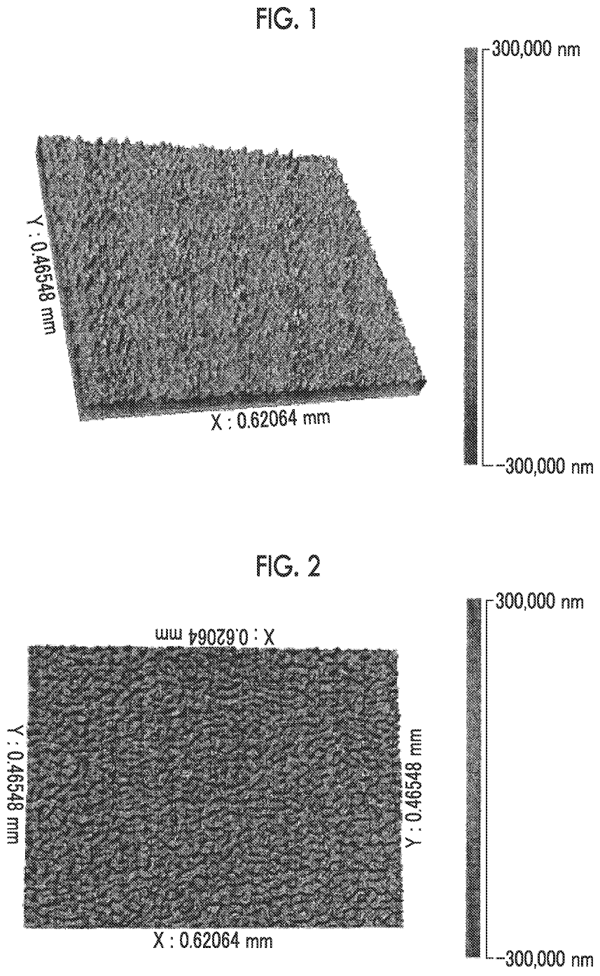

FIGS. 1 and 2 show a 3D image and a planar image, which are scanning white light interference micrographs, of the surface of the second layer of the antiglare film obtained in Example 1.

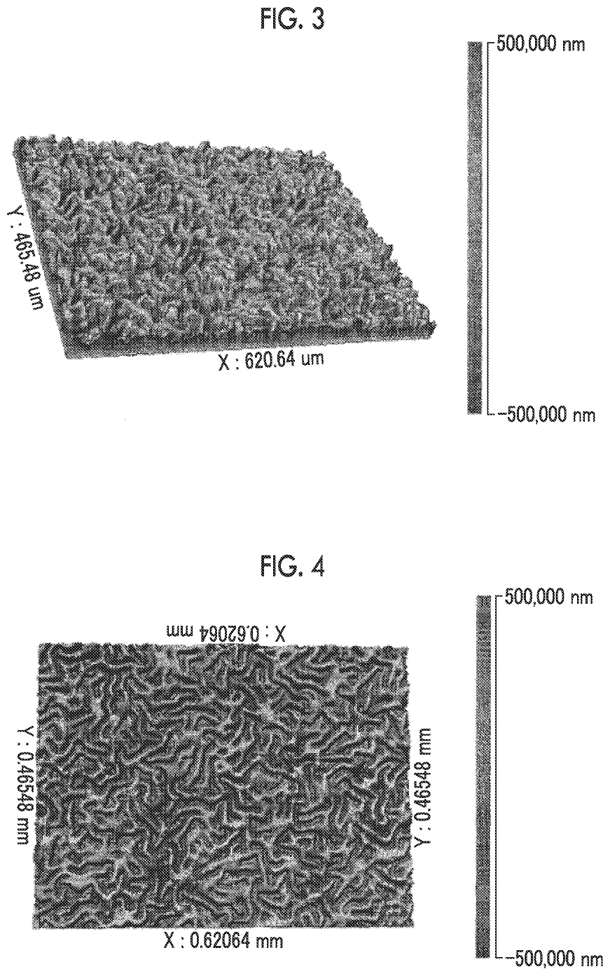

FIGS. 3 and 4 show a 3D image and a planar image, which are scanning white light interference micrographs, of the surface of the second layer of the antiglare film obtained in Example 2.

The axis shown on the right side in FIGS. 1 to 4 represents height.

<Evaluation of Antiglare Film>

(Scratch Resistance)

The surface of the scratch resistant layer of the antiglare film was subjected to a rubbing test using a rubbing tester under the following conditions.

Environmental conditions for evaluation: 25° C., relative humidity 60%

Rubbing Material: steel wool (NIHON STEEL WOOL Co., Ltd., grade No. 0000)

The steel wool was wound around the rubbing tip portion (2 cm×2 cm) of the tester coming into contact with the sample and fixed with a band.

Moving distance (one way): 13 cm

Rubbing speed: 13 cm/sec

Load: 1 k/cm²

Contact area of tip portion: 2 cm×2 cm

Number of times of rubbing: rubbed back and forth 10 times, 100 times, 250 times, and 500 times

After the test, an oil-based black ink was applied to a surface (surface of the substrate) of the antiglare film that was opposite to the rubbed surface (surface of the scratch resistant layer). The reflected light was visually observed, the number of times of rubbing that caused scratches in the portion contacting the steel wool was counted, and the scratch resistance was evaluated.

A: No scratch occurred even though the sample was rubbed back and forth 500 times.

B: No scratch occurred even though the sample was rubbed back and forth 250 times. However, in a case where the sample was rubbed back and forth 500 times, scratches occurred.

C: No scratch occurred even though the sample was rubbed back and forth 100 times. However, in a case where the sample was rubbed back and forth 250 times, scratches occurred.

D: No scratch occurred even though the sample was rubbed back and forth 10 times. However, in a case where the sample was rubbed back and forth 100 times, scratches occurred.

E: Scratches occurred in a case where the sample was rubbed back and forth 10 times.

(Glare)

The prepared antiglare film was used in a smartphone (iPhone (registered trademark) 6s manufactured by Apple Inc.), and the display unit of the smartphone was caused to display solid green. In this state, the extent to which the partial extension or contraction of B, G, and R pixels are unevenly visually observed (glare) was visually evaluated based on the following standard.

A: Glare is not recognized.

B: Although glare is recognized, it does not feel uncomfortable.

C: Although glare is recognized, it substantially does not feel uncomfortable.

D: Glare is recognized and feels uncomfortable.

E: Glare is recognized and feels very uncomfortable.

| | | | First layers | | | | | | | |
|---|---|---|---|---|---|---|---|---|---|---|
| | | | | | | | | | Consumption | |
| | Substrate | | Composition | UV | | | | | rate of | |
| | | Film | for forming | irradation | Film | | | | polymerizable | Recovery |
| | | thickness | hardcoat | dose | thickness | | G1 | Sa2 | groups | rate |
| | type | (μm) | layer | (mJ/cm²) | (μm) | n1 | (GPa) | (mm) | (%) | (%) |
| Example 1 | S-1 | 50 | HC-1 | 60 | 4.8 | 1.52 | 7.7 | 2.1 | 16 | 17% |
| Example 2 | S-1 | 50 | HC-1 | 20 | 4.9 | 1.52 | 7.7 | 2.8 | 3 | 2% |
| Example 3 | S-1 | 50 | HC-t | 120 | 5.0 | 1.52 | 7.7 | 1.6 | 21 | 263% |
| Example 4 | S-1 | 50 | HC-l | 60 | 4.7 | 1.52 | 7.7 | 2.5 | 17 | 17% |
| Example 5 | S-1 | 50 | HC-2 | 2 | 4.7 | 1.52 | 64 | 1.2 | 36 | 47% |
| Example 6 | S-1 | 50 | HC-3 | 60 | 4.7 | 1.52 | 7.8 | 2.2 | 36 | 43% |
| Ezample 7 | S-1 | 50 | HC-l | 60 | 4.7 | 1.52 | 7.7 | 2.2 | 17 | 17% |
| Comparative | S-1 | 50 | HC-l | 20 | 4.9 | 1.52 | 7.7 | 2.8 | 3 | 2% |
| Example 1 | | | | | | | | | | |
| Comparative | S-1 | 50 | HC-l | 60 | 4.8 | 1.52 | 7.7 | 2.1 | 16 | 17% |
| Example 2 | | | | | | | | | | |
| Comparative | 5-1 | 50 | HC-l | 60 | 4.8 | 1.52 | 7.7 | 2.1 | 16 | 17% |
| Example 3 | | | | | | | | | | |
| Comparative | S-1 | 30 | HC-2 | 60 | 4.7 | 1 53 | 6.4 | 3.4 | 69 | 54% |
| Example 4 | | | | | | | | | | |
| Comparative | Trade name (PF 23-115 from Daicel Corporation) | | | | | | | | | |
| Example 5 | | | | | | | | | | |
| | | | | | | Second layers. | | | | |
| | | | | | | Composition | Concentration | | | |
| | | | | | | for forming | of solid | Film | | |
| | | | | | | scratch | contents | thickness | | G2 |
| | | | | | | resistant ayer | (%) | (μm) | n2 | (GPa) |
| | | | | | Example 1 | SR-1 | 25 | 0.8 | 1.53 | 8.6 |
| | | | | | Example 2 | SR-1 | 25 | 0.8 | 1.53 | 8.6 |
| | | | | | Example 3 | SR-1 | 25 | 0.8 | 1.53 | 8.6 |
| | | | | | Example 4 | SR-1 | 25 | 0.7 | 1.53 | 8.6 |
| | | | | | Example 5 | SR-5 | 25 | 0.7 | 1.53 | 6.4 |
| | | | | | Example 6 | SR-3 | 25 | 0.7 | 1.53 | 8.9 |
| | | | | | Ezample 7 | SR-1 | 20 | 0.7 | 1.53 | 8.6 |
| | | | | | Comparative | SR-2 | 15 | 0.8 | 1.53 | 8.6 |
| | | | | | Example 1 | | | | | |
| | | | | | Comparative | SR-4 | 26 | 0.7 | 1.53 | 9.1 |
| | | | | | Example 2 | | | | | |
| | | | | | Comparative | SR-6 | 25 | 0.7 | 1.53 | 9.4 |
| | | | | | Example 3 | | | | | |
| | | | | | Comparative | SR-5 | 25 | 0.7 | 1.53 | 7.8 |
| | | | | | Example 4 | | | | | |
| | | | | | Comparative | Trade name (PF 23-115 from Daicel Corporation) | | | | |
| | | | | | Example 5 | | | | | |

TABLE 2

| | Characteristics of film | | | | | | |
|---|---|---|---|---|---|---|---|
| | | | Average | | | | |
| | | | distance | | | | |
| | | | between | | | | |
| | Haze | Sa | projections | | | Evaluation | |
| | (%) | (μm) | (μm) | Δ₁₁ | ΔG | Scratch resistance | Glare |
| Example 1 | 6.0 | 47 | 15 | 0.01 | 0.9 | A | A |
| Example 2 | 10.2 | 100 | 60 | 0.01 | 0.9 | B | B |
| Example 3 | 3.0 | 40 | 12 | 0.01 | 0.9 | A | A |
| Example 4 | 6.0 | 51 | 20 | 0.01 | 0.9 | A | A |
| Example 5 | 8.0 | 63 | 50 | 0.00 | 0.0 | B | B |
| Example 6 | 5.0 | 45 | 30 | 0.00 | 1.1 | A | A |
| Example 7 | 7.5 | 157 | 17 | 0.01 | 0.9 | B | B |
| Comparative | 15.0 | 200 | 80 | 0.01 | 0.9 | E | D |
| Example 1 | | | | | | | |
| Comparative | 0.6 | 25 | 100 | 0.01 | 1.4 | A | A |
| Example 2 | | | | | | | |
| Comparative | 0.5 | 28 | 80 | 0.01 | 1.7 | A | A |
| Example 3 | | | | | | | |
| Comparative | 0.4 | 21 | 60 | 0.00 | 1.4 | E | B |
| Example 4 | | | | | | | |
| Comparative | 7.5 | 42 | 14 | Unknown | Unknown | E | A |
| Example 5 | | | | | | | |

From the results shown in Tables 1 and 2, it has been revealed that the antiglare films of examples have excellent antiglare characteristics, suppress glare, and have excellent scratch resistance.

According to the present invention, it is possible to provide an antiglare film that has excellent antiglare characteristics, suppresses glare, and has excellent scratch resistance and to provide a manufacturing method of the antiglare film.

The present invention has been described in detail with reference to specific embodiments. To those skilled in the art, it is obvious that various changes or modifications can be added without departing from the gist and scope of the present invention.

What is claimed is:

1. An antiglare film comprising, in the following order:
a substrate;
a first layer; and
a second layer,
wherein the second layer has an uneven structure including elongated projection portions on a surface opposite to a side of the substrate,
an arithmetic mean height Sa of the surface of the second layer opposite to the side of the substrate is 30 to 160 nm,
an average distance between adjacent elongated projection portions in the uneven structure is 5 to 80 μm,
a content of particles having a particle diameter of 300 nm or more in the second layer is 0% to 0.1% by mass with respect to a total mass of the second layer,
an average film thickness of the second layer is 0.3 to 3 μm,
a haze of the antiglare film is 1% to 20%, and
in a case where a surface of the antiglare film opposite to the side of the substrate is rubbed 100 times back and forth with #0000 steel wool under a load of 1 kg/cm², no scratch occurs.

2. The antiglare film according to claim 1,
wherein an absolute value Δn of a difference between a refractive index n1 of the first layer and a refractive index n2 of the second layer, the Δn being represented by the following Equation (i), is 0.05 or less,
Δn=|n1−n2|. (i)

3. The antiglare film according to claim 1,
wherein an absolute value ΔG of a difference between an elastic modulus G1 of the first layer and an elastic modulus G2 of the second layer, the ΔG being represented by the following Equation (ii), is 2 GPa or less,
ΔG=|G1−G2|. (ii)

4. The antiglare film according to claim 2,
wherein an absolute value ΔG of a difference between an elastic modulus G1 of the first layer and an elastic modulus G2 of the second layer, the ΔG being represented by the following Equation (ii), is 2 GPa or less,
ΔG=|G1−G2|. (ii)

5. The antiglare film according to claim 1,
wherein the arithmetic mean height Sa of the surface of the second layer opposite to the side of the substrate is 40 to 100 nm.

6. The antiglare film according to claim 2,
wherein the arithmetic mean height Sa of the surface of the second layer opposite to the side of the substrate is 40 to 100 nm.

7. The antiglare film according to claim 3,
wherein the arithmetic mean height Sa of the surface of the second layer opposite to the side of the substrate is 40 to 100 nm.

8. The antiglare film according to claim 4,
wherein the arithmetic mean height Sa of the surface of the second layer opposite to the side of the substrate is 40 to 100 nm.

9. The antiglare film according to claim 1,
wherein the haze of the antiglare film is 5% to 10%.

10. The antiglare film according to claim 1,
wherein the average distance between adjacent elongated projection portions in the uneven structure is 5 to 15 μm.

11. A manufacturing method of an antiglare film having a substrate, a first layer, and a second layer in this order, in which the second layer has an uneven structure including elongated projection portions on a surface opposite to a side of the substrate, an arithmetic mean height Sa of the surface of the second layer opposite to the side of the substrate is 30 to 160 nm, an average distance between adjacent elongated projection portions in the uneven structure is 5 to 80 μm, a content of particles having a particle diameter of 300 nm or more in the second layer is 0% to 0.1% by mass with respect to a total mass of the second layer, an average film thickness of the second layer is 0.3 to 3 μm a haze of the antiglare film is 1% to 20%, and in a case where a surface of the antiglare film opposite to the side of the substrate is rubbed 100 times back and forth with #0000 steel wool under a load of 1 kg/cm², no scratch occurs, the manufacturing method comprising, in the following order:
coating the substrate with a composition for forming a first layer containing a polymerizable compound (a1) to form a first layer coating film;
semi-curing the first layer coating film;
coating the semi-cured first layer coating film with a composition for forming a second layer to form a second layer coating film; and
curing the semi-cured first layer coating film and the second layer coating film to form the first layer and the second layer.

12. The manufacturing method of an antiglare film according to claim 11,
wherein an arithmetic mean height Sat of a surface of the first layer coating film semi-cured in the semi-curing, the surface being opposite to the side of the substrate, is 30 nm or less.

13. The manufacturing method of an antiglare film according to claim 11,
wherein a consumption rate of polymerizable groups in the polytnerizable compound (a1) in the first layer coating film semi-cured in the semi-curing is 1% to 40%.

14. The manufacturing method of an antiglare film according to claim 11,
wherein a recovery rate of the first layer coating film semi-cured in the semi-curing is 2% to 50%.
